(19) United States
(12) Patent Application Publication
(10) Pub. No.: US 2012/0327092 A1
(43) Pub. Date: Dec. 27, 2012

(54) PLANARIZED SPACER FOR COVER PLATE OVER ELECTROMECHANICAL SYSTEMS DEVICE ARRAY

(75) Inventor: Teruo Sasagawa, Los Gatos, CA (US)

(73) Assignee: QUALCOMM MEMS Technologies, Inc., San Diego, CA (US)

(21) Appl. No.: 13/240,452

(22) Filed: Sep. 22, 2011

Related U.S. Application Data
(60) Provisional application No. 61/499,282, filed on Jun. 21, 2011.

(51) Int. Cl. G06T 1/00; C23F 1/02; B05D 3/10; G02B 26/00; B05D 5/00

(52) U.S. Cl. 345/501; 359/290; 359/291; 427/58; 216/13

(57) ABSTRACT

This disclosure provides systems, methods and apparatus for a MEMS device. In one aspect, an electromechanical systems apparatus includes a substrate, a stationary electrode positioned over the substrate, a movable electrode spaced from the stationary electrode by a gap, and at least one support structure extending above the movable electrode. The support structure includes an inorganic dielectric layer and a polymer layer.

### CROSS-REFERENCE TO RELATED APPLICATIONS

This disclosure claims priority to U.S. Provisional Patent Application No. 61/499,282, filed Jun. 21, 2011, entitled “PLANARIZED SPACER FOR COVER PLATE OVER ELECTROMECHANICAL SYSTEMS DEVICE ARRAY,” and assigned to the assignee hereof. The disclosure of the prior application is considered part of, and is incorporated by reference in, this disclosure.

### TECHNICAL FIELD

This disclosure relates to planarized spacers for spacing a cover plate over an array of electromechanical systems devices.

### DESCRIPTION OF THE RELATED TECHNOLOGY

Electromechanical systems include devices having electrical and mechanical elements, actuators, transducers, sensors, optical components (e.g., minors) and electronics. Electromechanical systems can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of electromechanical systems device is called an interferometric modulator (IMOD). As used herein, the term interferometric modulator or interferometric light modulator refers to a device that selectively absorbs and/or reflects light using the principles of optical interference. In some implementations, an interferometric modulator may include a pair of conductive plates, one or both of which may be transparent and/or reflective, wholly or in part, and capable of relative motion upon application of an appropriate electrical signal. In an implementation, one plate may include a stationary layer deposited on a substrate and the other plate may include a metallic membrane separated from the stationary layer by an air gap. The position of one plate in relation to another can change the optical interference of light incident on the interferometric modulator. Interferometric modulator devices have a wide range of applications, and are anticipated to be used in improving existing products and creating new products, especially those with display capabilities.

### SUMMARY

The systems, methods and devices of the disclosure each have several innovative aspects, no single one of which is solely responsible for the desirable attributes disclosed herein.

One innovative aspect of the subject matter described in this disclosure can be implemented in an electromechanical systems apparatus. The apparatus includes a substrate, a stationary electrode positioned over the substrate, and a movable electrode spaced from the stationary electrode by a gap. The apparatus further includes at least one support structure extending above the movable electrode where the support structure includes an inorganic dielectric layer and a polymer layer.

The electromechanical systems apparatus can include a cover plate supported over and spaced from the movable electrode by the support structure. The electromechanical systems apparatus can also include an array of interferometric modulators disposed on the substrate of which the movable electrode is part, where the at least one support structure is disposed within the array. The electromechanical systems apparatus can further include posts between each interferometric modulator, where at least some of the posts support the movable electrode and underlie the support structure. In some implementations, the inorganic dielectric layer overlies the polymer layer. Additionally, in some implementations, the at least one support structure has a substantially planarized upper surface.

Another innovative aspect of the subject matter described in this disclosure can be implemented in a display system. The system includes a substrate and an array of electromechanical systems devices formed on the substrate. Each electromechanical systems device includes a stationary electrode formed on the substrate and a movable electrode spaced from the stationary electrode by a gap. The display system further includes a set of support structures within the array, where each support structure extends above the array. Each of the support structures include an inorganic dielectric layer and a polymer layer. In some implementations, the inorganic dielectric layer is deposited directly over the polymer layer, and may collectively be referred to as a bilayer. In certain implementations, the display system includes a cover plate above the array, where each support structure is between the cover plate and the array.

Another innovative aspect of the subject matter described in this disclosure can be implemented in an electromechanical systems apparatus. The apparatus includes a substrate, a stationary electrode positioned over the substrate, a movable electrode spaced from the stationary electrode by a gap, and means for spacing from the movable electrode, where the means for spacing includes an inorganic dielectric layer and a polymer layer.

Another innovative aspect of the subject matter described in this disclosure can be implemented in a method of manufacturing an electromechanical systems apparatus. The method includes providing an electromechanical systems device having a substrate, a stationary electrode above the substrate, and a movable electrode above the stationary electrode. The method further includes forming a support layer over the movable electrode, wherein the support layer includes an inorganic dielectric layer over a polymer layer.

In some implementations, the method further includes providing a cover plate over the support layer. The method can further include forming a mask over the support layer and patterning the support layer to form a plurality of support structures that space the cover plate from the movable electrode. Patterning the support layer can include dry etching the inorganic dielectric layer, and patterning the support layer can include oxygen plasma etching the polymer layer. In some implementations, forming the support layer includes self-planarizing deposition of the polymer layer prior to depositing the inorganic dielectric layer. In some implementations, the method can include depositing a sacrificial layer over the stationary electrode, the sacrificial layer between and the stationary electrode and the movable electrode and removing the sacrificial layer by applying an etchant.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of an isometric view depicting two adjacent pixels in a series of pixels of an interferometric modulator (IMOD) display device.

FIG. 2 shows an example of a system block diagram illustrating an electronic device incorporating a 3×3 interferometric modulator display.

FIG. 3 shows an example of a diagram illustrating movable reflective layer position versus applied voltage for the interferometric modulator of FIG. 1.

FIG. 4 shows an example of a table illustrating various states of an interferometric modulator when various common and segment voltages are applied.

FIG. 5A shows an example of a diagram illustrating a frame of display data in the 3×3 interferometric modulator display of FIG. 2.

FIG. 5B shows an example of a timing diagram for common and segment signals that may be used to write the frame of display data illustrated in FIG. 5A.

FIG. 6A shows an example of a partial cross-section of the interferometric modulator display of FIG. 1.

FIGS. 6B-6E show examples of cross-sections of varying implementations of interferometric modulators.

FIG. 7 shows an example of a flow diagram illustrating a manufacturing process for an interferometric modulator.

FIGS. 8A-8E show examples of cross-sectional schematic illustrations of various stages in a method of making an interferometric modulator.

FIG. 9 illustrates an example of a schematic cross-section of an array of electromechanical systems devices.

FIG. 10 illustrates a top plan view of an array of electromechanical systems devices, showing a plurality of spacers within the array.

FIG. 11 shows an example of a schematic cross section of an electromechanical systems device having inorganic spacers produced for spacing a cover plate above the device, taken along lines 11-11 of FIG. 10.

FIG. 12 illustrates a schematic cross section taken along lines 12-12 of FIG. 10, after the spacers have been etched as shown in FIG. 11.

FIG. 13 shows an example of a schematic cross section of an implementation of an electromechanical systems device array having spacers formed of a bilayer of an inorganic layer and a polymer layer for spacing a cover plate above the device array.

FIG. 14 shows an example of a flow diagram illustrating a method of making an electromechanical systems device in accordance with one implementation.

FIG. 15 shows another example of a flow diagram illustrating a method of making an electromechanical systems device according to another implementation.

FIGS. 16A-16H show an example of a series of schematic cross sections illustrating a process for manufacturing an electromechanical systems device corresponding to FIG. 15.

FIGS. 17A and 17B show examples of system block diagrams illustrating a display device that includes a plurality of interferometric modulators.

Like reference numbers and designations in the various drawings indicate like elements.

### DETAILED DESCRIPTION

The following detailed description is directed to certain implementations for the purposes of describing the innovative aspects. However, the teachings herein can be applied in a multitude of different ways. The described implementations may be implemented in any device that is configured to display an image, whether in motion (e.g., video) or stationary (e.g., still image), and whether textual, graphical or pictorial. More particularly, it is contemplated that the implementations may be implemented in or associated with a variety of electronic devices such as, but not limited to, mobile telephones, multimedia Internet enabled cellular telephones, mobile television receivers, wireless devices, smartphones, bluetooth devices, personal data assistants (PDAs), wireless electronic mail receivers, hand-held or portable computers, netbooks, notebooks, smartbooks, printers, copiers, scanners, facsimile devices, GPS receivers/navigators, cameras, MP3 players, camcorders, game consoles, wrist watches, clocks, calculators, television monitors, flat panel displays, electronic reading devices (e.g., e-readers), computer monitors, auto displays (e.g., odometer display, etc.), cockpit controls and/or displays, camera view displays (e.g., display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (e.g., MEMS and non-MEMS), aesthetic structures (e.g., display of images on a piece of jewelry) and a variety of electromechanical systems devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes, and electronic test equipment. Thus, the teachings are not intended to be limited to the implementations depicted solely in the Figures, but instead have wide applicability as will be readily apparent to a person having ordinary skill in the art.

In fabricating an array of electromechanical systems devices, spacers or support structures may be formed within the array to space a cover plate (e.g., back plate) above the electromechanical systems devices. In some implementations, the support structures include a bilayer of a polymer and an inorganic dielectric spacer.

Particular implementations of the subject matter described in this disclosure can be implemented to realize one or more of the following potential advantages. The underlying polymer can serve to planarize the dielectric spacer, provide elastomeric resiliency to absorb pressure from mounting the cover plate, and also act as an etch stop. The overlying inorganic layer can lend hardness predictability to the support structures without sacrificing planarity, since it is formed over a planar polymer layer.

One example of a suitable MEMS device, to which the described implementations may apply, is a reflective display device. Reflective display devices can incorporate interferometric modulators (IMODs) to selectively absorb and/or reflect light incident thereon using principles of optical interference. IMODs can include an absorber, a reflector that is movable with respect to the absorber, and an optical resonant cavity defined between the absorber and the reflector. The reflector can be moved to two or more different positions, which can change the size of the optical resonant cavity and thereby affect the reflectance of the interferometric modulator. The reflectance spectrums of IMODs can create fairly broad spectral bands which can be shifted across the visible wavelengths to generate different colors. The position of the spectral band can be adjusted by changing the thickness of the optical resonant cavity, e.g., by changing the position of the reflector.

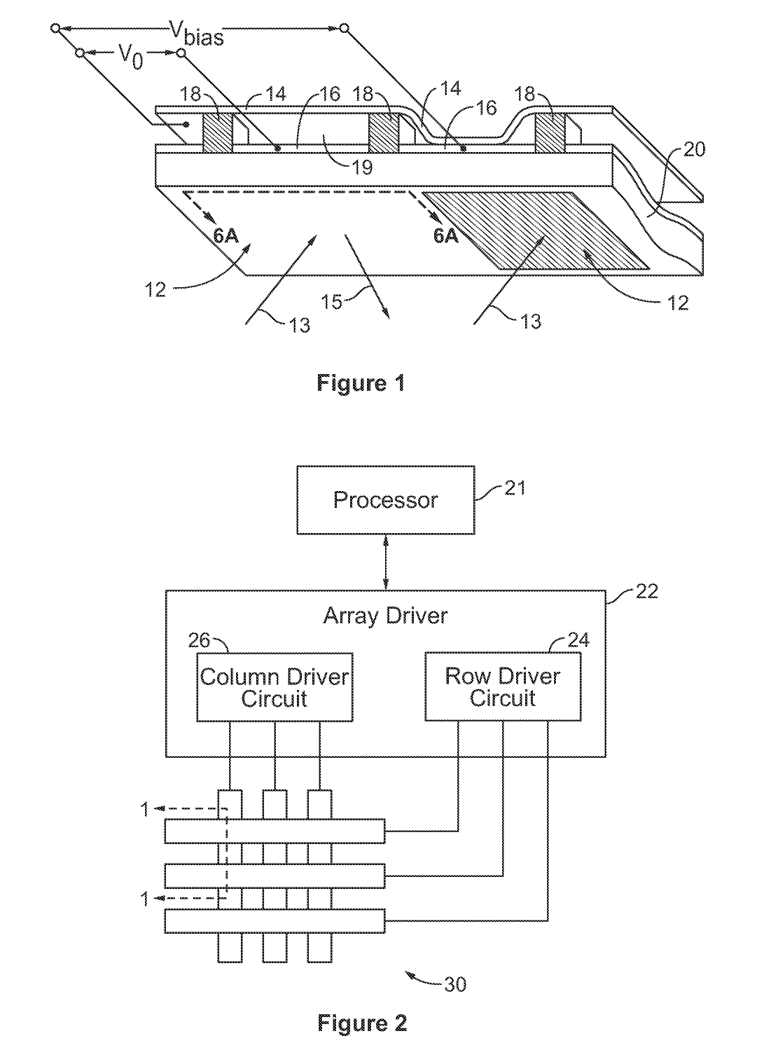

FIG. 1 shows an example of an isometric view depicting two adjacent pixels in a series of pixels of an interferometric modulator (IMOD) display device. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light, e.g., to a user. Conversely, in the dark (“actuated,” “closed” or “off”) state, the display element reflects little incident visible light. In some implementations, the light reflectance properties of the on and off states may be reversed. MEMS pixels can be configured to reflect predominantly at particular wavelengths, allowing for a color display in addition to black and white.

The IMOD display device can include a row/column array of IMODs. Each IMOD can include a pair of reflective layers, e.g., a movable reflective layer and a fixed partially reflective layer, positioned at a variable and controllable distance from each other to form an air gap (also referred to as an optical gap or cavity). The movable reflective layer may be moved between at least two positions. In a first position, e.g., a relaxed position, the movable reflective layer can be positioned at a relatively large distance from the fixed partially reflective layer. In a second position, e.g., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when unactuated, reflecting light outside of the visible range (e.g., infrared light). In some other implementations, however, an IMOD may be in a dark state when unactuated, and in a reflective state when actuated. In some implementations, the introduction of an applied voltage can drive the pixels to change states. In some other implementations, an applied charge can drive the pixels to change states.

The depicted portion of the pixel array in FIG. 1 includes two adjacent interferometric modulators 12. In the IMOD 12 on the left (as illustrated), a movable reflective layer 14 is illustrated in a relaxed position at a predetermined distance from an optical stack 16, which includes a partially reflective layer. The voltage V₀ applied across the IMOD 12 on the left is insufficient to cause actuation of the movable reflective layer 14. In the IMOD 12 on the right, the movable reflective layer 14 is illustrated in an actuated position near or adjacent the optical stack 16. The voltage V_{bias} applied across the IMOD 12 on the right is sufficient to maintain the movable reflective layer 14 in the actuated position.

In FIG. 1, the reflective properties of pixels 12 are generally illustrated with arrows 13 indicating light incident upon the pixels 12, and light 15 reflecting from the pixel 12 on the left. Although not illustrated in detail, it will be understood by a person having ordinary skill in the art that most of the light 13 incident upon the pixels 12 will be transmitted through the transparent substrate 20, toward the optical stack 16. A portion of the light incident upon the optical stack 16 will be transmitted through the partially reflective layer of the optical stack 16, and a portion will be reflected back through the transparent substrate 20. The portion of light 13 that is transmitted through the optical stack 16 will be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the pixel 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals, e.g., chromium (Cr), semiconductors, and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and conductor, while different, more conductive layers or portions (e.g., of the optical stack 16 or of other structures of the IMOD) can serve to bus signals between IMOD pixels. The optical stack 16 also can include one or more insulating or dielectric layers covering one or more conductive layers or a conductive/absorptive layer.

In some implementations, the layer(s) of the optical stack 16 can be patterned into parallel strips, and may form row electrodes in a display device as described further below. As will be understood by one having skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of posts 18 and an intervening sacrificial material deposited between the posts 18. When the sacrificial material is etched away, a defined gap 19, or optical cavity, can be formed between the movable reflective layer 14 and the optical stack 16. In some implementations, the spacing between posts 18 may be on the order of 1-1000 μm, while the gap 19 may be on the order of <10,000 Angstroms (Å).

In some implementations, each pixel of the IMOD, whether in the actuated or relaxed state, is essentially a capacitor formed by the fixed and movable reflective layers. When no voltage is applied, the movable reflective layer 14a remains in a mechanically relaxed state, as illustrated by the pixel 12 on the left in FIG. 1, with the gap 19 between the movable reflective layer 14 and optical stack 16. However, when a potential difference, e.g., voltage, is applied to at least one of a selected row and column, the capacitor formed at the intersection of the row and column electrodes at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated pixel 12 on the right in FIG. 1. The behavior is the same regardless of the polarity of the applied potential difference. Though a series of pixels in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 2 shows an example of a system block diagram illustrating an electronic device incorporating a 3×3 interferometric modulator display. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, e.g., a display array or panel 30. The cross section of the IMOD display device illustrated in FIG. 1 is shown by the lines 1-1 in FIG. 2. Although FIG. 2 illustrates a 3×3 array of IMODs for the sake of clarity, the display array 30 may contain a very large number of IMODs, and may have a different number of IMODs in rows than in columns, and vice versa.

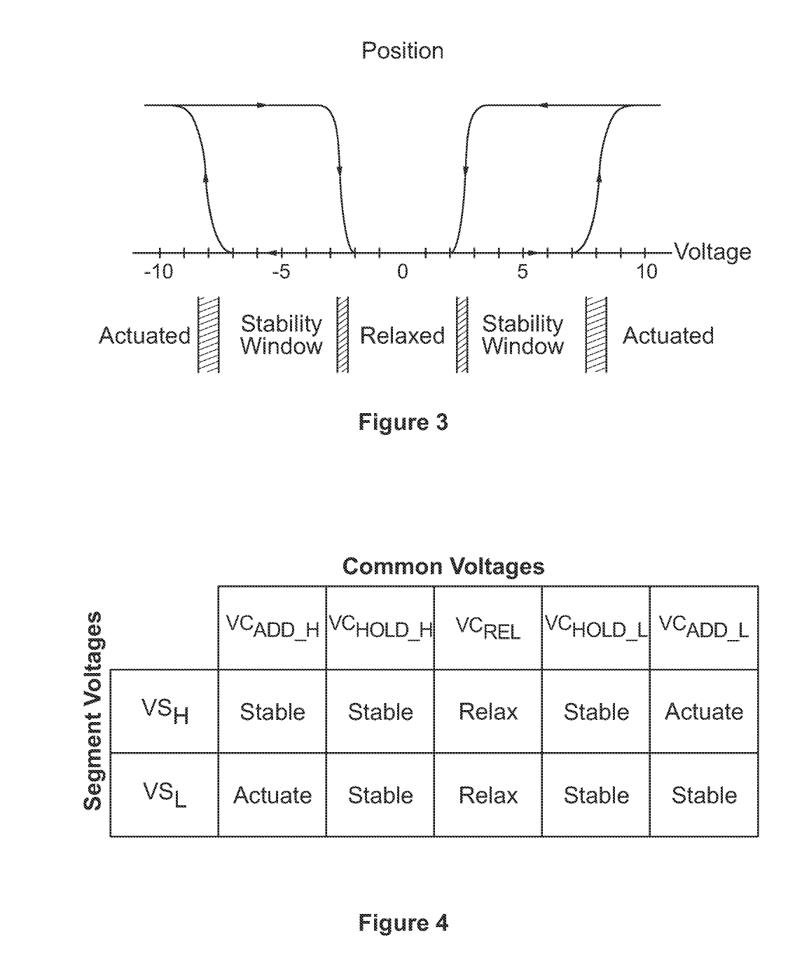

FIG. 3 shows an example of a diagram illustrating movable reflective layer position versus applied voltage for the interferometric modulator of FIG. 1. For MEMS interferometric modulators, the row/column (i.e., common/segment) write procedure may take advantage of a hysteresis property of these devices as illustrated in FIG. 3. An interferometric modulator may require, for example, about a 10-volt potential difference to cause the movable reflective layer, or minor, to change from the relaxed state to the actuated state. When the voltage is reduced from that value, the movable reflective layer maintains its state as the voltage drops back below, e.g., 10-volts, however, the movable reflective layer does not relax completely until the voltage drops below 2-volts. Thus, a range of voltage, approximately 3 to 7-volts, as shown in FIG. 3, exists where there is a window of applied voltage within which the device is stable in either the relaxed or actuated state. This is referred to herein as the “hysteresis window” or “stability window.” For a display array 30 having the hysteresis characteristics of FIG. 3, the row/column write procedure can be designed to address one or more rows at a time, such that during the addressing of a given row, pixels in the addressed row that are to be actuated are exposed to a voltage difference of about 10-volts, and pixels that are to be relaxed are exposed to a voltage difference of near zero volts. After addressing, the pixels are exposed to a steady state or bias voltage difference of approximately 5-volts such that they remain in the previous strobing state. In this example, after being addressed, each pixel sees a potential difference within the “stability window” of about 3-7-volts. This hysteresis property feature enables the pixel design, e.g., illustrated in FIG. 1, to remain stable in either an actuated or relaxed pre-existing state under the same applied voltage conditions. Since each IMOD pixel, whether in the actuated or relaxed state, is essentially a capacitor formed by the fixed and movable reflective layers, this stable state can be held at a steady voltage within the hysteresis window without substantially consuming or losing power. Moreover, essentially little or no current flows into the IMOD pixel if the applied voltage potential remains substantially fixed.

In some implementations, a frame of an image may be created by applying data signals in the form of “segment” voltages along the set of column electrodes, in accordance with the desired change (if any) to the state of the pixels in a given row. Each row of the array can be addressed in turn, such that the frame is written one row at a time. To write the desired data to the pixels in a first row, segment voltages corresponding to the desired state of the pixels in the first row can be applied on the column electrodes, and a first row pulse in the form of a specific “common” voltage or signal can be applied to the first row electrode. The set of segment voltages can then be changed to correspond to the desired change (if any) to the state of the pixels in the second row, and a second common voltage can be applied to the second row electrode. In some implementations, the pixels in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

The combination of segment and common signals applied across each pixel (that is, the potential difference across each pixel) determines the resulting state of each pixel. FIG. 4 shows an example of a table illustrating various states of an interferometric modulator when various common and segment voltages are applied. As will be readily understood by one having ordinary skill in the art, the “segment” voltages can be applied to either the column electrodes or the row electrodes, and the “common” voltages can be applied to the other of the column electrodes or the row electrodes.

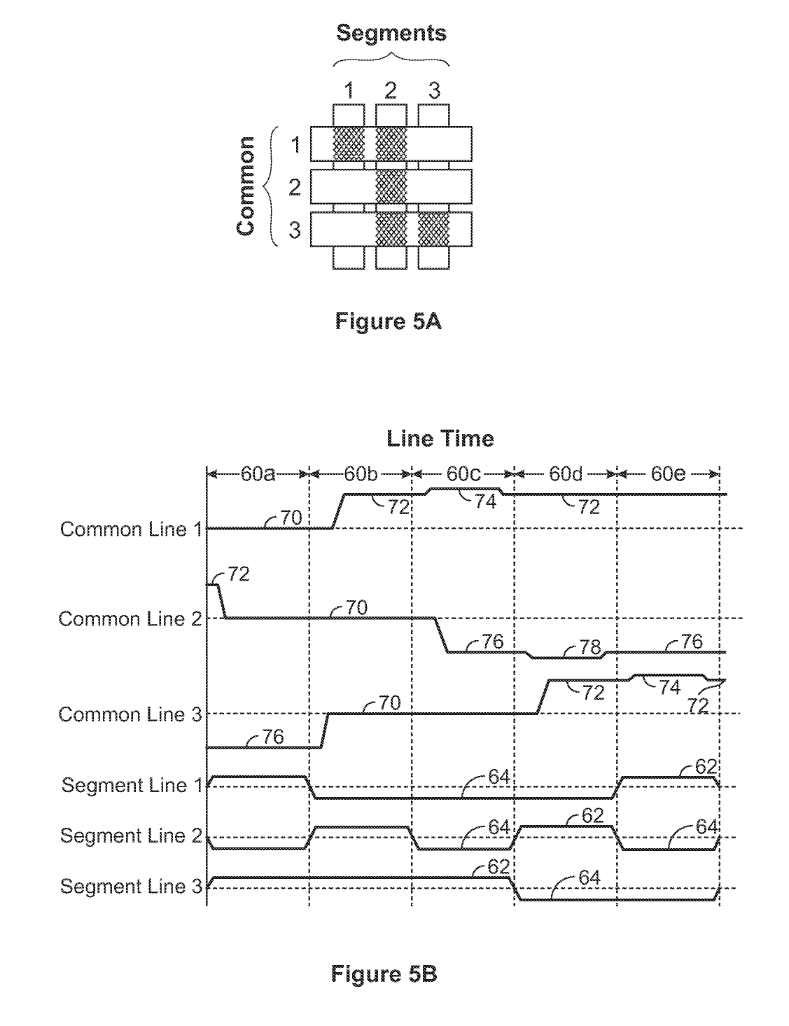

As illustrated in FIG. 4 (as well as in the timing diagram shown in FIG. 5B), when a release voltage VC_{REL} is applied along a common line, all interferometric modulator elements along the common line will be placed in a relaxed state, alternatively referred to as a released or unactuated state, regardless of the voltage applied along the segment lines, e.g., high segment voltage VS_{H} and low segment voltage VS_{L}. In particular, when the release voltage VC_{REL} is applied along a common line, the potential voltage across the modulator (alternatively referred to as a pixel voltage) is within the relaxation window (see FIG. 3, also referred to as a release window) both when the high segment voltage VS_{H} and the low segment voltage VS_{L} are applied along the corresponding segment line for that pixel.

When a hold voltage is applied on a common line, such as a high hold voltage VC_{HOLD}_{_{—}}_{H} or a low hold voltage VC_{HOLD}_{_{—}}_{L}, the state of the interferometric modulator will remain constant. For example, a relaxed IMOD will remain in a relaxed position, and an actuated IMOD will remain in an actuated position. The hold voltages can be selected such that the pixel voltage will remain within a stability window both when the high segment voltage VS_{H} and the low segment voltage VS_{L} are applied along the corresponding segment line. Thus, the segment voltage swing, i.e., the difference between the high VS_{H} and low segment voltage VS_{L}, is less than the width of either the positive or the negative stability window.

When an addressing, or actuation, voltage is applied on a common line, such as a high addressing voltage VC_{ADD}_{_{—}}_{H} or a low addressing voltage VC_{ADD}_{_{—}}_{L}, data can be selectively written to the modulators along that line by application of segment voltages along the respective segment lines. The segment voltages may be selected such that actuation is dependent upon the segment voltage applied. When an addressing voltage is applied along a common line, application of one segment voltage will result in a pixel voltage within a stability window, causing the pixel to remain unactuated. In contrast, application of the other segment voltage will result in a pixel voltage beyond the stability window, resulting in actuation of the pixel. The particular segment voltage which causes actuation can vary depending upon which addressing voltage is used. In some implementations, when the high addressing voltage VC_{ADD}_{_{—}}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_{—}}_{L} is applied, with high segment voltage VS_{H} causing actuation of the modulator, and low segment voltage VS_{L} having no effect (i.e., remaining stable) on the state of the modulator.

In some implementations, hold voltages, address voltages, and segment voltages may be used which always produce the same polarity potential difference across the modulators. In some other implementations, signals can be used which alternate the polarity of the potential difference of the modulators. Alternation of the polarity across the modulators (that is, alternation of the polarity of write procedures) may reduce or inhibit charge accumulation which could occur after repeated write operations of a single polarity.

FIG. 5A shows an example of a diagram illustrating a frame of display data in the 3×3 interferometric modulator display of FIG. 2. FIG. 5B shows an example of a timing diagram for common and segment signals that may be used to write the frame of display data illustrated in FIG. 5A. The signals can be applied to the, e.g., 3×3 array of FIG. 2, which will ultimately result in the line time 60e display arrangement illustrated in FIG. 5A. The actuated modulators in FIG. 5A are in a dark-state, i.e., where a substantial portion of the reflected light is outside of the visible spectrum so as to result in a dark appearance to, e.g., a viewer. Prior to writing the frame illustrated in FIG. 5A, the pixels can be in any state, but the write procedure illustrated in the timing diagram of FIG. 5B presumes that each modulator has been released and resides in an unactuated state before the first line time 60a.

During the first line time 60a: a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1,2) and (1,3) along common line 1 remain in a relaxed, or unactuated, state for the duration of the first line time 60a, the modulators (2,1), (2,2) and (2,3) along common line 2 will move to a relaxed state, and the modulators (3,1), (3,2) and (3,3) along common line 3 will remain in their previous state. With reference to FIG. 4, the segment voltages applied along segment lines 1, 2 and 3 will have no effect on the state of the interferometric modulators, as none of common lines 1, 2 or 3 are being exposed to voltage levels causing actuation during line time 60a (i.e., VC_{REL}-relax and VC_{HOLD}_{_{—}}_{L}-stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3,1), (3,2) and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the pixel voltage across modulators (1,1) and (1,2) is greater than the high end of the positive stability window (i.e., the voltage differential exceeded a predefined threshold) of the modulators, and the modulators (1,1) and (1,2) are actuated. Conversely, because a high segment voltage 62 is applied along segment line 3, the pixel voltage across modulator (1,3) is less than that of modulators (1,1) and (1,2), and remains within the positive stability window of the modulator; modulator (1,3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the pixel voltage across modulator (2,2) is below the lower end of the negative stability window of the modulator, causing the modulator (2,2) to actuate. Conversely, because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state.

Finally, during the fifth line time 60e, the voltage on common line 1 remains at high hold voltage 72, and the voltage on common line 2 remains at a low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth line time 60e, the 3×3 pixel array is in the state shown in FIG. 5A, and will remain in that state as long as the hold voltages are applied along the common lines, regardless of variations in the segment voltage which may occur when modulators along other common lines (not shown) are being addressed.

In the timing diagram of FIG. 5B, a given write procedure (e.g., line times 60a-60e) can include the use of either high hold and address voltages, or low hold and address voltages. Once the write procedure has been completed for a given common line (and the common voltage is set to the hold voltage having the same polarity as the actuation voltage), the pixel voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the necessary line time. Specifically, in implementations in which the release time of a modulator is greater than the actuation time, the release voltage may be applied for longer than a single line time, as depicted in FIG. 5B. In some other implementations, voltages applied along common lines or segment lines may vary to account for variations in the actuation and release voltages of different modulators, such as modulators of different colors.

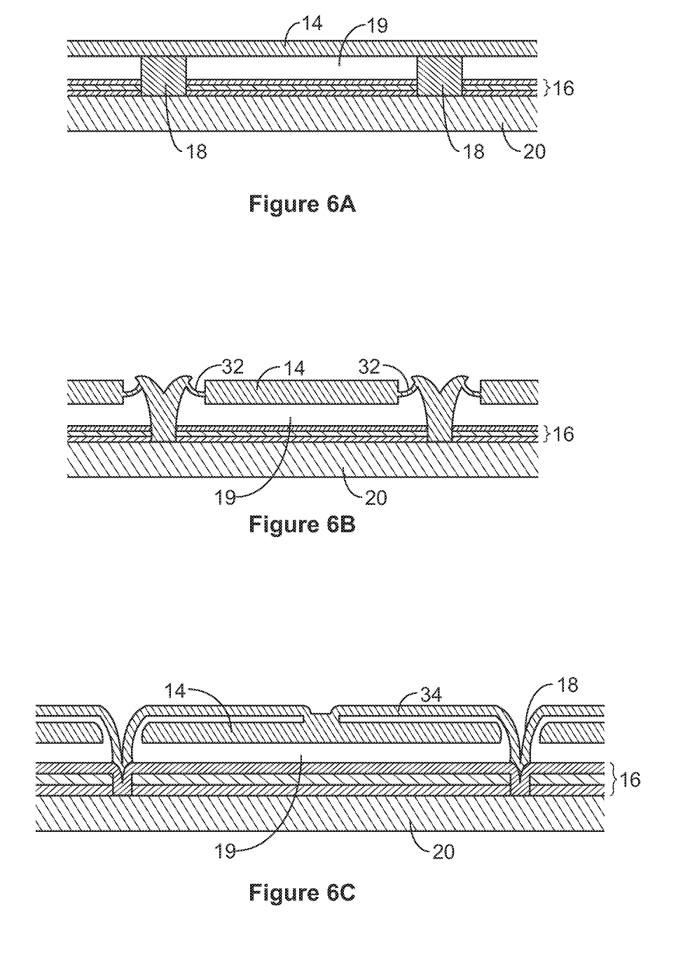

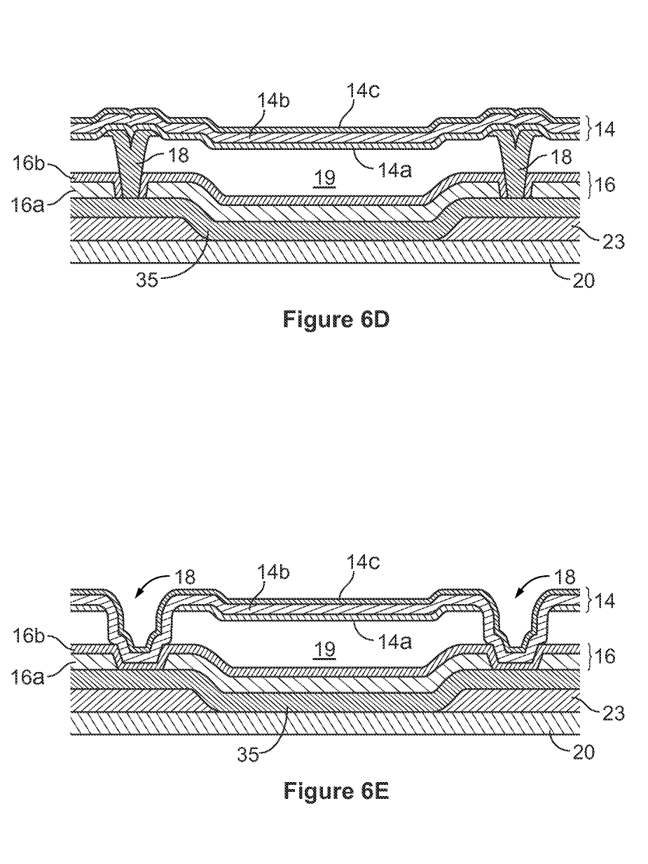

The details of the structure of interferometric modulators that operate in accordance with the principles set forth above may vary widely. For example, FIGS. 6A-6E show examples of cross-sections of varying implementations of interferometric modulators, including the movable reflective layer 14 and its supporting structures. FIG. 6A shows an example of a partial cross-section of the interferometric modulator display of FIG. 1, where a strip of metal material, i.e., the movable reflective layer 14 is deposited on supports 18 extending orthogonally from the substrate 20. In FIG. 6B, the movable reflective layer 14 of each IMOD is generally square or rectangular in shape and attached to supports at or near the corners, on tethers 32. In FIG. 6C, the movable reflective layer 14 is generally square or rectangular in shape and suspended from a deformable layer 34, which may include a flexible metal. The deformable layer 34 can connect, directly or indirectly, to the substrate 20 around the perimeter of the movable reflective layer 14. These connections are herein referred to as support posts. The implementation shown in FIG. 6C has additional benefits deriving from the decoupling of the optical functions of the movable reflective layer 14 from its mechanical functions, which are carried out by the deformable layer 34. This decoupling allows the structural design and materials used for the reflective layer 14 and those used for the deformable layer 34 to be optimized independently of one another. In the illustrated example, the deformable layer 34 also provides supports 18 for itself and the movable reflective layer 14.

FIG. 6D shows another example of an IMOD, where the movable reflective layer 14 includes a reflective sub-layer 14a. The movable reflective layer 14 rests on a support structure, such as support posts 18. The support posts 18 provide separation of the movable reflective layer 14 from the lower stationary electrode (i.e., part of the optical stack 16 in the illustrated IMOD) so that a gap 19 is formed between the movable reflective layer 14 and the optical stack 16, for example when the movable reflective layer 14 is in a relaxed position. The movable reflective layer 14 also can include a conductive layer 14c, which may be configured to serve as an electrode, and a support layer 14b. In this example, the conductive layer 14c is disposed on one side of the support layer 14b, distal from the substrate 20, and the reflective sub-layer 14a is disposed on the other side of the support layer 14b, proximal to the substrate 20. In some implementations, the reflective sub-layer 14a can be conductive and can be disposed between the support layer 14b and the optical stack 16. The support layer 14b can include one or more layers of a dielectric material, for example, silicon oxynitride (SiOₓN_{y}) or silicon dioxide (SiO₂). In some implementations, the support layer 14b can be a stack of layers, such as, for example, a SiO₂/SiOₓN_{y}/SiO₂ tri-layer stack. Either or both of the reflective sub-layer 14a and the conductive layer 14c can include, e.g., an Al alloy with about 0.5% Cu, or another reflective metallic material. Employing conductive layers 14a, 14c above and below the dielectric support layer 14b can balance stresses and provide enhanced conduction. In some implementations, the reflective sub-layer 14a and the conductive layer 14c can be formed of different materials for a variety of design purposes, such as achieving specific stress profiles within the movable reflective layer 14.

As illustrated in FIG. 6D, some implementations also can include a black mask structure 23. The black mask structure 23 can be formed in optically inactive regions (e.g., between pixels or under supports 18) to absorb ambient or stray light. The black mask structure 23 also can improve the optical properties of a display device by inhibiting light from being reflected from or transmitted through inactive portions of the display, thereby increasing the contrast ratio. Additionally, the black mask structure 23 can be conductive and be configured to function as an electrical bussing layer. In some implementations, the row electrodes can be connected to the black mask structure 23 to reduce the resistance of the connected row electrode. The black mask structure 23 can be formed using a variety of methods, including deposition and patterning techniques. The black mask structure 23 can include one or more layers. For example, in some implementations, the black mask structure 23 includes a molybdenum-chromium (MoCr) layer that serves as an optical absorber, a SiO₂ layer, and an aluminum alloy that serves as a reflector and a bussing layer, with a thickness in the range of about 30-80 Å, 500-1000 Å, and 500-6000 Å, respectively. The one or more layers can be patterned using a variety of techniques, including photolithography and dry etching, such as CF₄ and/or O₂ for the MoCr and SiO₂ layers and Cl₂ and/or BCl₃ for the aluminum alloy layer. In some implementations, the black mask 23 can be an etalon or interferometric stack structure. In such interferometric stack black mask structures 23, the conductive absorbers can be used to transmit or bus signals between lower, stationary electrodes in the optical stack 16 of each row or column. In some implementations, a spacer layer 35 can serve to generally electrically isolate the absorber layer 16a from the conductive layers in the black mask 23.

FIG. 6E shows another example of an IMOD, where the movable reflective layer 14 is self supporting. In contrast with FIG. 6D, the implementation of FIG. 6E does not include separately formed supports. Instead, the movable reflective layer 14 contacts the underlying optical stack 16 at multiple locations, and the curvature of the movable reflective layer 14 itself provides supports 18 sufficient for the movable reflective layer 14 to return to the unactuated position of FIG. 6E when the voltage across the interferometric modulator is insufficient to cause actuation. The optical stack 16, which may contain a plurality of several different layers, is shown here for clarity including an optical absorber 16a, and a dielectric 16b. In some implementations, the optical absorber 16a may serve both as a fixed electrode and as a partially reflective layer.

In implementations such as those shown in FIGS. 6A-6E, the IMODs function as direct-view devices, in which images are viewed from the front side of the transparent substrate 20, i.e., the side opposite to that upon which the modulator is arranged. In these implementations, the back portions of the device (that is, any portion of the display device behind the movable reflective layer 14, including, for example, the deformable layer 34 illustrated in FIG. 6C) can be configured and operated upon without impacting or negatively affecting the image quality of the display device, because the reflective layer 14 optically shields those portions of the device. For example, in some implementations a bus structure (not illustrated) can be included behind the movable reflective layer 14 which provides the ability to separate the optical properties of the modulator from the electromechanical properties of the modulator, such as voltage addressing and the movements that result from such addressing. Additionally, the implementations of FIGS. 6A-6E can simplify processing, such as, e.g., patterning.

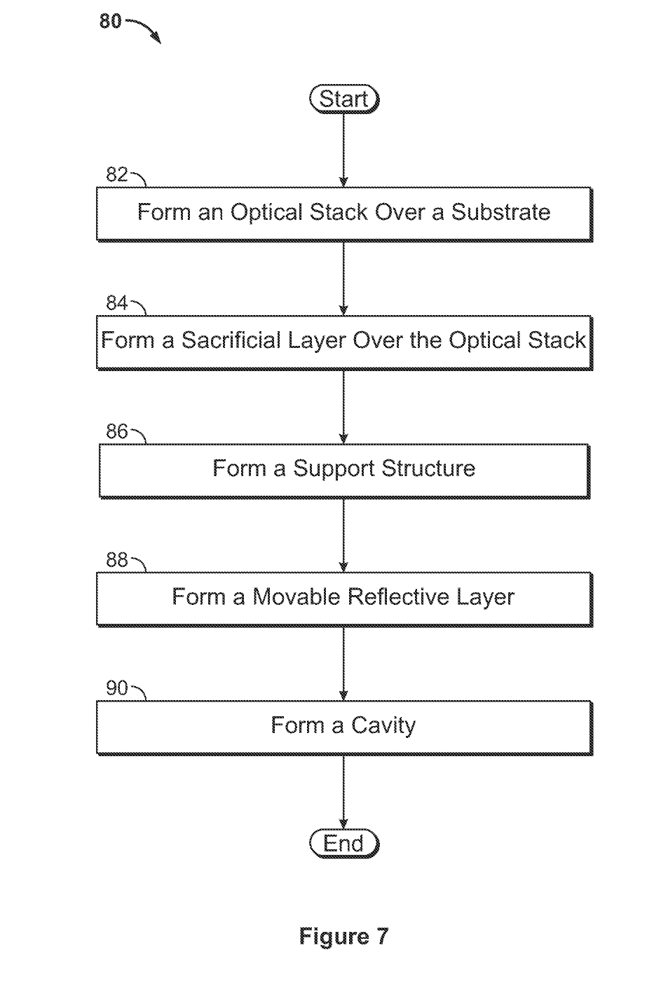

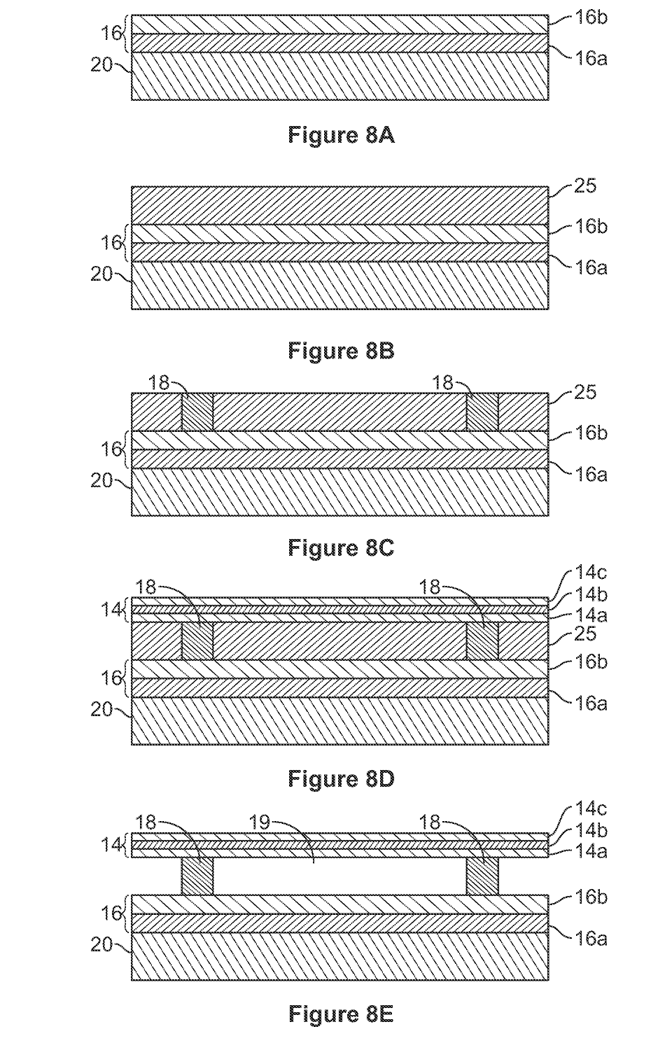

FIG. 7 shows an example of a flow diagram illustrating a manufacturing process 80 for an interferometric modulator, and FIGS. 8A-8E show examples of cross-sectional schematic illustrations of corresponding stages of such a manufacturing process 80. In some implementations, the manufacturing process 80 can be implemented to manufacture, e.g., interferometric modulators of the general type illustrated in FIGS. 1 and 6A-6E, in addition to other blocks not shown in FIG. 7. It will be understood that the process of FIG. 7 can be performed to produce structures different from those of FIGS. 8A-8E, which depict particularly simplified interferometric modulators for purposes of illustration.

With reference to FIGS. 1, 6A-6E and 7, the process 80 begins at block 82 with the formation of the optical stack 16 over the substrate 20. FIG. 8A illustrates such an optical stack 16 formed over the substrate 20. The substrate 20 may be a transparent substrate such as glass or plastic, it may be flexible or relatively stiff and unbending, and may have been subjected to prior preparation processes, e.g., cleaning, to facilitate efficient formation of the optical stack 16. As discussed above, the optical stack 16 can be electrically conductive, partially transparent and partially reflective and may be fabricated, for example, by depositing one or more layers having the desired properties onto the transparent substrate 20. In FIG. 8A, the optical stack 16 includes a multilayer structure having sub-layers 16a and 16b, although more or fewer sub-layers may be included in some other implementations. In some implementations, one of the sub-layers 16a, 16b can be configured with both optically absorptive and conductive properties, such as the combined conductor/absorber sub-layer 16a. Additionally, one or more of the sub-layers 16a, 16b can be patterned into parallel strips, and may form row electrodes in a display device. Such patterning can be performed by a masking and etching process or another suitable process known in the art. In some implementations, one of the sub-layers 16a, 16b can be an insulating or dielectric layer, such as sub-layer 16b that is deposited over one or more metal layers (e.g., one or more reflective and/or conductive layers). In addition, the optical stack 16 can be patterned into individual and parallel strips that form the rows of the display.

The process 80 continues at block 84 with the formation of a sacrificial layer 25 over the optical stack 16. The sacrificial layer 25 is later removed (e.g., at block 90) to form the cavity 19 and thus the sacrificial layer 25 is not shown in the resulting interferometric modulators 12 illustrated in FIG. 1. FIG. 8B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (Si), in a thickness selected to provide, after subsequent removal, a gap or cavity 19 (see also FIGS. 1 and 8E) having a desired design size. Deposition of the sacrificial material may be carried out using deposition techniques such as physical vapor deposition (PVD, e.g., sputtering), plasma-enhanced chemical vapor deposition (PECVD), thermal chemical vapor deposition (thermal CVD), or spin-coating.

The process 80 continues at block 86 with the formation of a support structure e.g., a post 18 as illustrated in FIGS. 1, 6A-6E and 8C. The formation of the post 18 may include patterning the sacrificial layer 25 to form a support structure aperture, then depositing a material (e.g., a polymer or an inorganic material, e.g., silicon oxide) into the aperture to form the post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the post 18 contacts the substrate 20 as illustrated in FIG. 6A. Alternatively, as depicted in FIG. 8C, the aperture formed in the sacrificial layer 25 can extend through the sacrificial layer 25, but not through the optical stack 16. For example, FIG. 8E illustrates the lower ends of the support posts 18 in contact with an upper surface of the optical stack 16. The post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 8C, but also can, at least partially, extend over a portion of the sacrificial layer 25. As noted above, the patterning of the sacrificial layer 25 and/or the support posts 18 can be performed by a masking and etching process, but also may be performed by alternative patterning methods.

The process 80 continues at block 88 with the formation of a movable reflective layer or membrane such as the movable reflective layer 14 illustrated in FIGS. 1, 6A-6E and 8D. The movable reflective layer 14 may be formed by employing one or more depositions, e.g., reflective layer (e.g., aluminum, aluminum alloy) deposition, along with one or more patterning, masking, and/or etching processes. The movable reflective layer 14 can be electrically conductive, and referred to as an electrically conductive layer. In some implementations, the movable reflective layer 14 may include a plurality of sub-layers 14a, 14b, 14c as shown in FIG. 8D. In some implementations, one or more of the sub-layers, such as sub-layers 14a, 14c, may include highly reflective sub-layers selected for their optical or electrical properties, and another sub-layer 14b may include a mechanical sub-layer selected for its mechanical properties. Since the sacrificial layer 25 is still present in the partially fabricated interferometric modulator formed at block 88, the movable reflective layer 14 is typically not movable at this stage. A partially fabricated IMOD that contains a sacrificial layer 25 may also be referred to herein as an “unreleased” IMOD. As described above in connection with FIG. 1, the movable reflective layer 14 can be patterned into individual and parallel strips that form the columns of the display.

The process 80 continues at block 90 with the formation of a cavity, e.g., cavity 19 as illustrated in FIGS. 1, 6A-6E and 8E. The cavity 19 may be formed by exposing the sacrificial material 25 (deposited at block 84) to an etchant. For example, an etchable sacrificial material such as Mo or amorphous Si may be removed by dry chemical etching, e.g., by exposing the sacrificial layer 25 to a gaseous or vaporous etchant, such as vapors derived from solid XeF₂, for a period of time that is effective to remove the desired amount of material, typically selectively removed relative to the structures surrounding the cavity 19. Other etching methods, e.g., wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD may be referred to herein as a “released” IMOD.

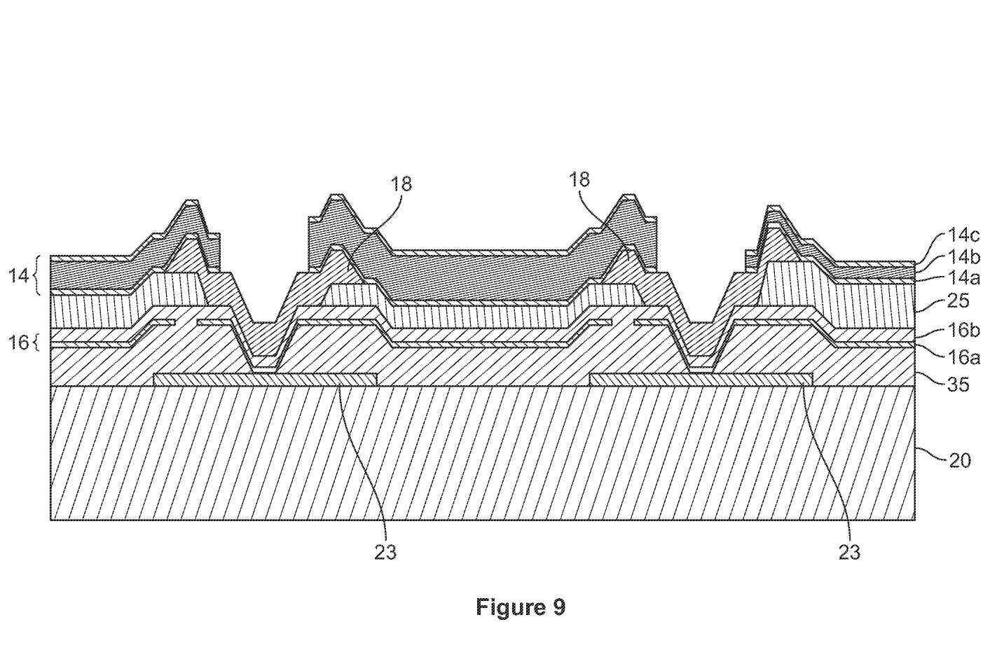

FIG. 9 illustrates an example of a schematic cross-section of an array of electromechanical systems devices. One such electromechanical systems device is an interferometric modulator (IMOD) as described above. In the illustrated implementation, an IMOD array is formed on a transparent substrate 20. The device can include one or more layers above the substrate 20, such as a dielectric spacer or buffer layer 35 and/or black masks 23. An optical stack 16 can form an optically active surface over the substrate 20, which can include an absorber layer 16a and a dielectric layer 16b. A movable reflective layer 14 can be supported by support posts 18, or other support structures (e.g., walls or rails). In the illustrated implementation, the overlap of layers may create some uneven surface topography.

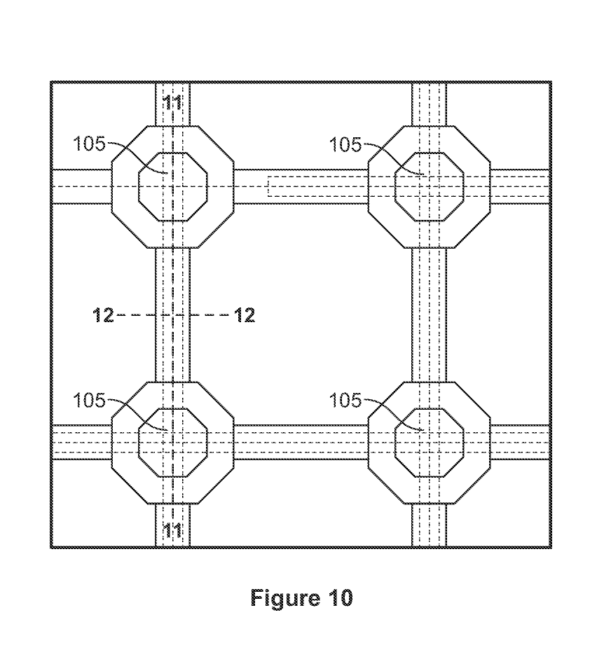

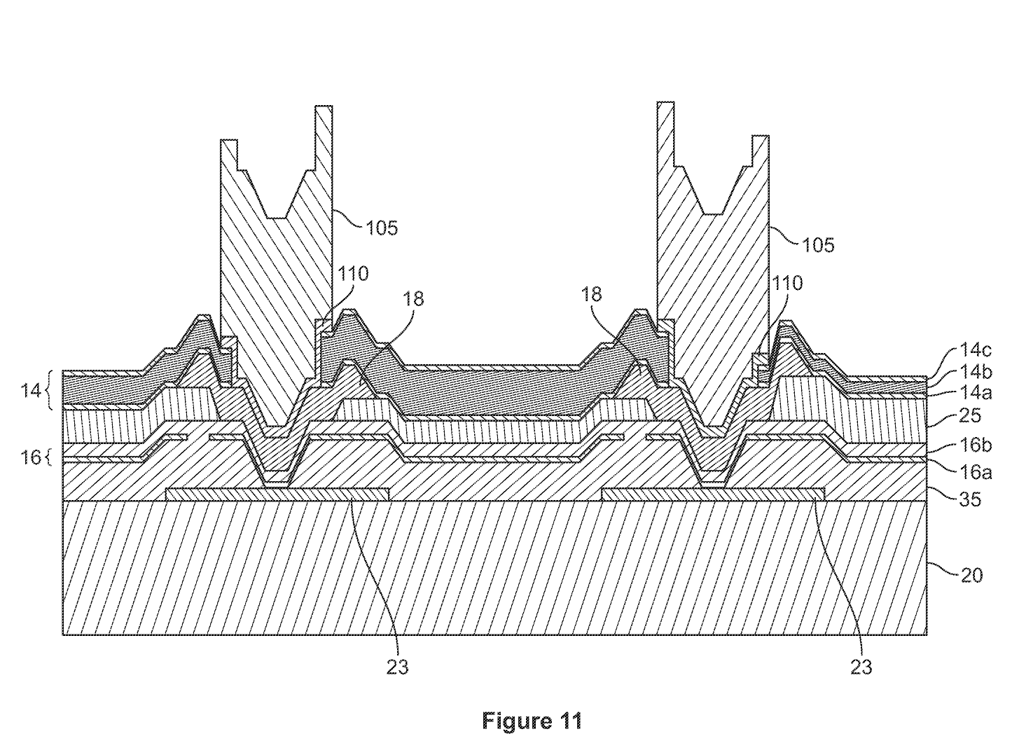

FIG. 10 illustrates a top plan view of an array of electromechanical systems devices, showing a plurality of spacers within the array. For example, the electromechanical systems device can include an array of IMODs providing a plurality of pixels. A plurality of spacers 105 are formed in the midst of an array of IMODs. This can serve to reduce pressure-related variability across the array of IMODs from a cover plate. The spacers 105 can reduce damage to the IMODs. As illustrated in FIG. 10, the spacers 105 are arranged in a substantially regular pattern over the array of IMODs, with the spacers 105 arranged at the corners of pixels. While shown in locations overlapping with support posts 18 (see FIG. 11 below), one having ordinary skill in the art will recognize that the spacers 105 can be provided at fewer locations distributed across the array.

FIG. 11 shows an example of a schematic cross section of an electromechanical systems device having inorganic spacers produced for spacing a cover plate above the device, taken along lines 11-11 of FIG. 10. The spacers 105 can protect the electromechanical systems device from contact with the cover plate, particularly when the cover plate is subjected to a deforming force. A typical inorganic dielectric spacer 105 (e.g., SiO, or SiOₓN_{y}) may have an etch stop layer 110, such as aluminum nitride (AlNₓ) beneath it that is resistant to fluorine-based etchants. The etch stop layer 110 can also be selectively removed after etching the inorganic dielectric spacer 105, which can involve Cl₂ plasma etching. However, some materials (such as AlNₓ) for this etch stop layer 110 are typically sputter deposited. Moreover, in some implementations, the spacers 105 are not planar due to deposition over non-planar topography created by overlapping layers and, in a color IMOD application, different cavity sizes and/or different thicknesses of the movable reflective layer 14 in the IMOD array. Because the top profile of the spacers 105 is not flat in some implementations, the pressure from a cover glass (not shown) resting upon the spacers 105 is not uniformly distributed and tends to break the spacers 105 more easily.

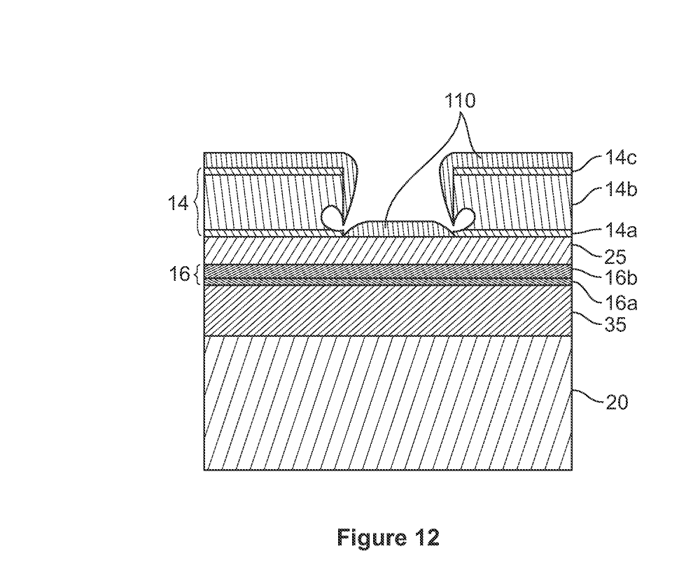

FIG. 12 illustrates a schematic cross section taken along lines 12-12 of FIG. 10, after the spacers have been etched as shown in FIG. 11. The cross section is shown in a region between strips of the movable reflective layer 14, away from the support posts 18. Because a typical sputter deposition of the etch stop layer 110 (e.g., AlNₓ) is not a conformal process, another drawback is that the AlNₓ etch stop layer 110 does not completely cover the underlying layers of the IMOD, especially the areas with steep sidewalls. For example, the vertical sidewalls of the movable reflective layer 14 may be exposed during the removal of the etch stop layer 110 because of the poor step coverage of the AlNₓ deposition. Thus, a fluorine-based etch of the inorganic spacer 105, which is selective to materials, such as SiO₂, SiOₓN_{y}, etc., can damage the movable reflective layer 14 when the movable reflective layer 14 includes a material such as SiOₓN_{y}. In addition, while the AlNₓ can be etched by a Cl₂ plasma etch without attacking the underlying layers of the IMOD, removal of the AlNₓ from the vertical sidewall of the movable reflective layer 14 can be difficult.

Thus, a need exists for an electromechanical systems apparatus with spacers having planarized surfaces to provide an even spacer height across the array and uniformly distribute pressure from the cover plate. Furthermore, a need exists for a manufacturing process with an effective etch stop that minimizes damage to underlying layers while patterning the spacers and that can be completely removed without damage to underlying layers.

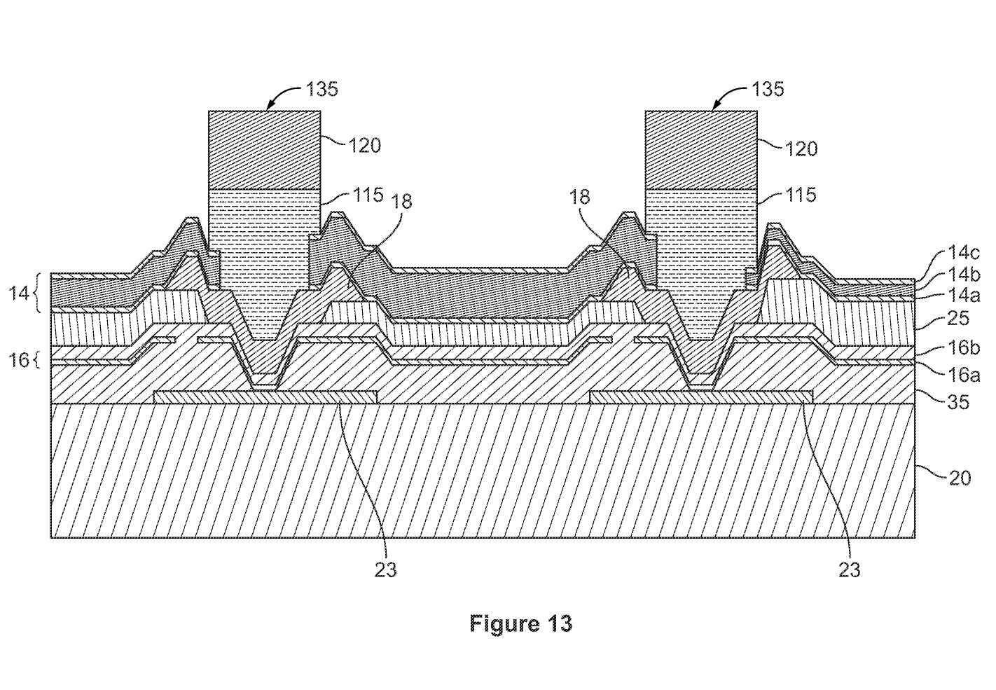

FIG. 13 shows an example of a schematic cross section of an implementation of an electromechanical systems device array having spacers 135 formed of a bilayer of an inorganic layer 120 and a polymer layer 115 for spacing a cover plate above the device array. The device can include a substrate 20. The substrate 20 can be substantially transparent and include glass or plastic. In some implementations, the device can include one or more layers over the substrate 20, such as a dielectric buffer layer 35 and/or a black mask 23. In the area immediately above the substrate 20, the dielectric buffer layer 35 can include, for example, silicon dioxide (SiO₂), silicon nitride (SiNₓ), or silicon oxynitride (SiOₓN_{y}). Furthermore, the black mask 23 can be positioned above the substrate 20 in certain sections of the device, and may be configured to absorb ambient or stray light in regions that are optically inactive (e.g., beneath supports and/or between pixels).

The electromechanical systems device array further includes a stationary electrode, which for the IMOD implementations is part of an optical stack 16 above the substrate 20. The optical stack 16 can include an absorber layer 16a, which can be partially transparent and may include 10 Å to 80 Å of a metallic or semiconductor film, such as molybdenum (Mo), chromium (Cr), silicon (Si), germanium (Ge), or mixtures thereof. The optical stack 16 can also include a dielectric layer 16b, which can include one or more dielectric materials, such as, for example, SiO₂, SiNₓ or SiOₓN_{y}. In some implementations, the thickness of the dielectric layer 16b is in the range of about 1000-5000 Å. However, the dielectric layer 16b can have a variety of thicknesses depending on the desired optical properties.

In addition, the electromechanical systems device can include other layers, for example, a transparent conductor (not shown), such as indium tin oxide (ITO). The optical stack 16 can thus be electrically conductive, partially transparent and partially reflective. In some implementations, one or more layers of the optical stack 16 may physically and electrically contact the black mask structure 23.

Also, the device can include a sacrificial layer 25 that is typically removed later to form a gap. The sacrificial layer 25 can be selected to include more than one layer, or include layers of varying thicknesses, to aid in the formation of a display device having multiple collapsible gaps or cavities of different sizes. For an IMOD array, each gap size corresponds to a different reflected color. For example, a gap size for the color blue can be between about 3100 Å to about 3900 Å; a gap size for the color red can be between about 2300 Å to about 2700 Å; and a gap size for the color green can be between about 1700 Å to about 1900 Å. Generally, the size of the gap can be between about 1000 Å and about 5000 Å for IMOD applications. Other gap sizes may be suitable for RF switch or other MEMS or NEMS applications.

With further reference to FIG. 13, the electromechanical systems device can also include support posts 18 or similar support structures. In an array of IMODs, a portion of each of the support posts 18 can be disposed between pixels or within pixels, and formed over the black mask structures 23. A portion of the support posts 18 can be in contact with and between the optical stack 16 and a movable reflective layer 14. After removal of the sacrificial layer 25, the support posts 18 can support the movable reflective layer 14 over the optical layer 16.

The device further includes a movable electrode or mechanical layer, also referred to herein as a movable reflective layer 14 for IMOD implementations. The movable reflective layer 14 can be made of any suitable materials. In order to facilitate use of the same actuation voltage to collapse the movable reflective layer 14 for multiple different gap sizes, the movable reflective layer 14 can have different thicknesses over differently sized gaps to provide different stiffnesses, as illustrated in FIG. 13. The movable reflective layer 14 can include different materials and/or different numbers of layers. In some implementations, the movable reflective layer 14 can include a SiOₓN_{y} support layer 14b sandwiched between a reflective surface 14a such as an aluminum alloy (0.5% Cu) mirror below and a similar aluminum alloy layer 14c above, as described with respect to FIGS. 6D and 6E. The movable reflective layer 14 can take any of the forms described above with respect to FIGS. 6A-6E above. In non-optical electromechanical systems devices, the movable reflective layer 14 may not include a reflective surface.

As illustrated in FIG. 13, the cover plate support structures or spacers 135 may be formed on and/or above the support posts 18. While FIG. 13 shows two spacers 135 over two support posts 18, it will be understood that spacers 135 can be provided on fewer than all support posts 18 in the array. The spacers 135 can provide support for a back plate or cover plate (not shown) that is provided over the array of IMODs. Moreover, the spacers 135 can space the cover plate a consistent distance from the movable reflective layer 14 in the array.

Each spacer 135 includes a bilayer of a polymer layer 115 and an inorganic layer 120. Suitable inorganic materials for layer 120 may include rigid materials, such as metals, metal oxides, calcium oxide, barium oxide, boric anhydride, phosphorus pentoxide, metal sulfates, calcium sulfate, magnesium sulfate, sodium sulfate, metals, sodium, lead/sodium alloy, metal hydrides, sodium borohydride, sodium hydride, lithium aluminum hydride, silica gel, activated alumina, zeolites, molecular sieves, phosphorus, metal salts, magnesium perchlorate, zinc chloride, and combinations or composites thereof. In some implementations, the inorganic layer 120 is transparent or translucent. In some implementations, the inorganic layer 120 may include dielectric materials such as silicon oxide (SiOₓ), silicon nitride (SiNₓ) or silicon oxynitride (SiOₓN_{y}).

The polymer layer 115, which underlies the inorganic layer 120 in the example of FIG. 12, is a more elastic material than the inorganic layer 120, and can include but is not limited to, polyamides, polyalkenes, polyfluoroalkenes, polyesters, polysulfones, polystyrene, polyurethanes, polyacrylates, and polyimides. In some implementations, the polymer layer 115 is a high temperature polymer, such as a fluorinated polymer, e.g., AL-X2000 manufactured by Asahi Glass Corporation, which is discussed in more detail below. The elasticity of the polymer layer 115 distributes pressure from the cover plate and provides shock absorption to protect the IMOD from mechanical impact. The thickness of the polymer layer 115 can be between about 0.3 μm and about 5.0 μm, e.g., between about 0.5 μm and about 1.5 μm.

The polymer layer 115 can be derived from a planar coating to planarize the dielectric support structure or spacer 135, so that the spacers 135 provide an even spacer height across the array and uniformly distribute pressure from the cover plate. The use of the inorganic layer 120 lends hardness predictability and strength to the spacers 135 without sacrificing planarity. For example, adding the inorganic layer 120 of thickness between about 1.5 μm and about 2.0 μm over the polymer layer 115 of thickness between 0.5 μm and 1.5 μm can provide the equivalent strength of a significantly thicker all-polymer spacer (e.g., 5.0 μm).

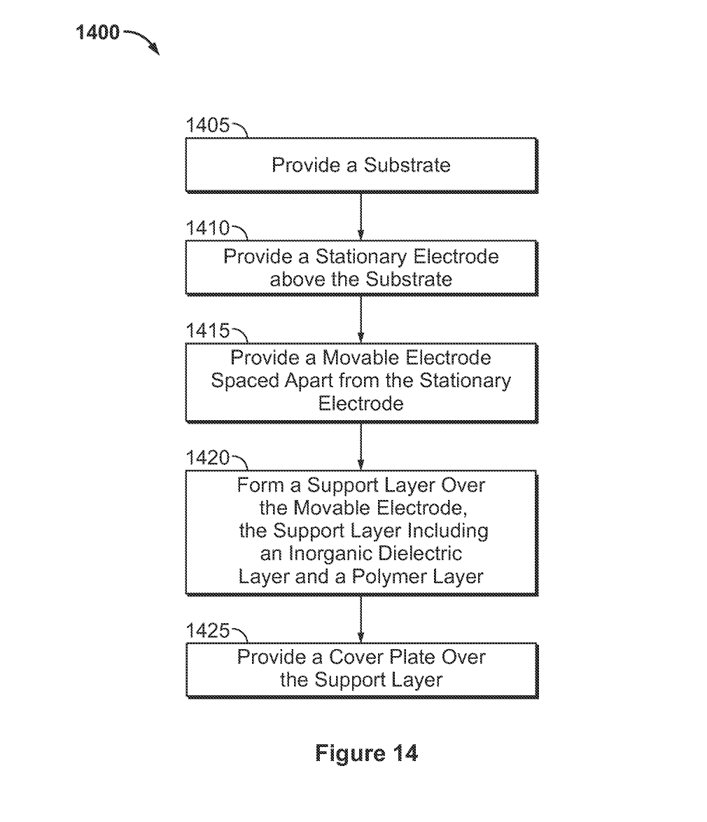

FIG. 14 shows an example of a flow diagram illustrating a method of making an electromechanical systems device in accordance with one implementation. Some of the blocks may be present in a process for manufacturing IMODs of the general type illustrated in FIGS. 1-8E, along with other blocks not shown in FIG. 14. For example, it will be understood that additional processes of depositing underlying or intervening layers, such as black mask layers, bussing layers, and absorber layers may be present.

The process 1400 begins at 1405 where a substrate is provided. In one implementation, the substrate may include a transparent material such as glass or plastic.

The process 1400 continues at block 1410 where a stationary electrode is formed over the substrate. In an IMOD example, the stationary electrode may form part of an optical stack, as described earlier herein. The stationary electrode can be fabricated by depositing one or more layers onto the transparent substrate. In some implementations, the layers are patterned into parallel strips, and may form row electrodes in a display device. Patterning can include both masking and etching processes. In some implementations, the stationary electrode includes an insulating or dielectric layer covering conductive layer(s).

The process 1400 continues at block 1415 where a movable electrode such as a mechanical layer is provided and spaced apart from the stationary electrode. The movable electrode can be fabricated by depositing one or more layers, along with patterning processes. In an IMOD example, the movable electrode can include a reflective layer. The electrodes may be spaced by a sacrificial material between the movable electrode and the stationary electrode, which can be later removed in a release etch to leave an air gap between the electrodes.

The process 1400 illustrated in FIG. 14 continues at block 1420 where a support layer is formed over the movable electrode. In some implementations, the support layer includes a bilayer of an inorganic dielectric layer and a polymer layer.

The process continues at block 1425 where a cover plate (e.g., back plate) is provided over the support layer. The cover plate may rest on the support layer, and can include one or more types of materials, for example, glass, metal, foil, polymer, plastic, and ceramic or semiconductor material (such as silicon). The cover plate of a package can provide protection for the electromechanical device formed by the electrodes against ambient conditions, such as temperature, pressure, or environmental conditions.

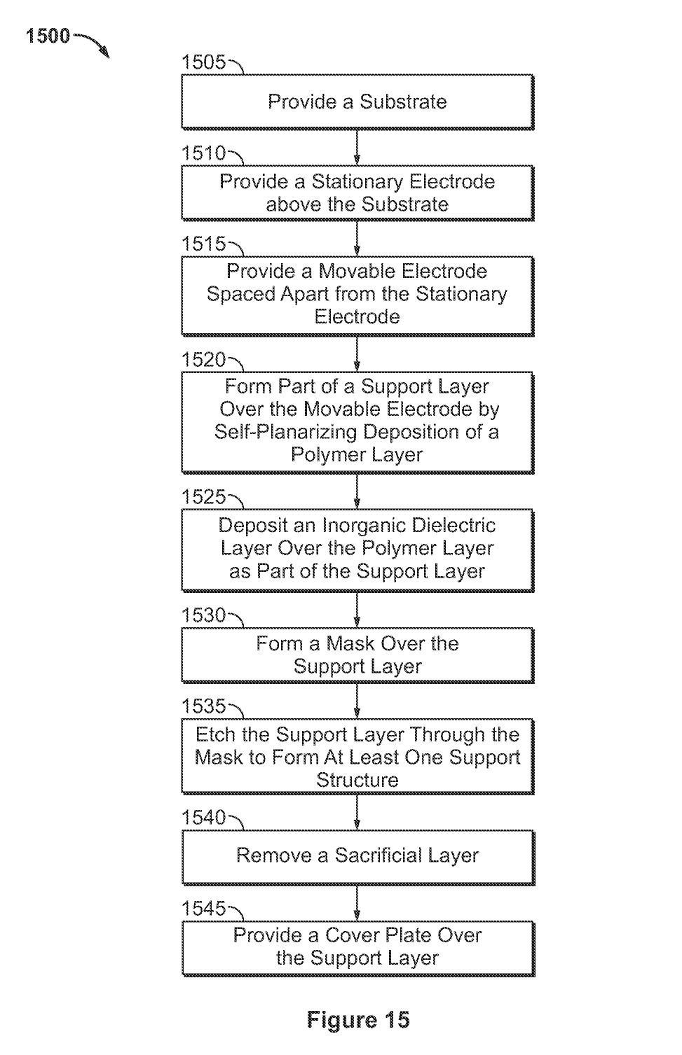

FIG. 15 shows another example of a flow diagram illustrating a method of making an electromechanical systems device according to another implementation. The process 1500 begins at blocks 1505, 1510, and 1515, which can be similar to blocks 1405, 1410, and 1415, respectively, as described with respect to FIG. 14.

The process 1500 proceeds in block 1520 by forming part of a support layer over the movable electrode through self-planarizing deposition of a polymer layer. The self-planarizing deposition of the polymer layer may take any of a number of forms, such as spin-on deposition, extrusion coating, spray coating, etc. Use of self-planarizing deposition can obviate subsequent planarizing processes, such as chemical mechanical polishing (CMP). In some implementations, the polymer material may be a liquid before cure. After deposition, the polymer layer can be subjected to a high temperature cure, e.g., between about 200° C. and about 450° C. The selected deposition technique will depend in part upon the selected material. As a result, the polymer layer can be deposited and cured with a flat top (e.g., planarized) surface.

The process 1500 continues in block 1525 by depositing an inorganic dielectric layer over the polymer layer as part of the support layer. The inorganic dielectric layer may be deposited using any of a variety of techniques, such as sputter deposition, thermal CVD, plasma-enhanced CVD, etc. The inorganic dielectric layer is deposited over the planar polymer layer so that the upper surface of the inorganic dielectric layer can also be planar, regardless of whether it is deposited by a conformal technique like CVD. Thus, the support layer includes a bilayer of an inorganic layer and an organic layer with a flat or planar top surface.

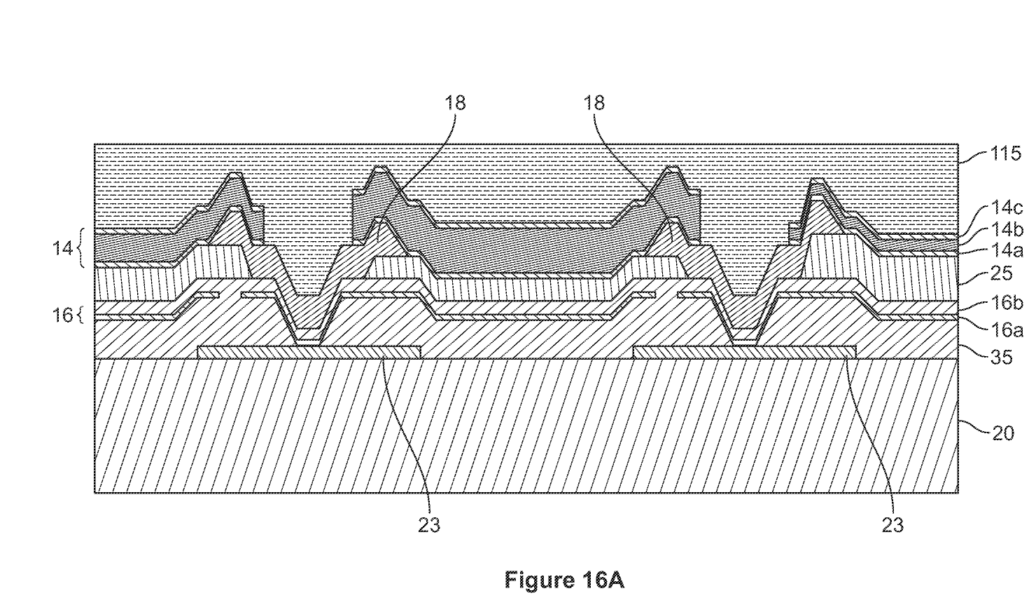

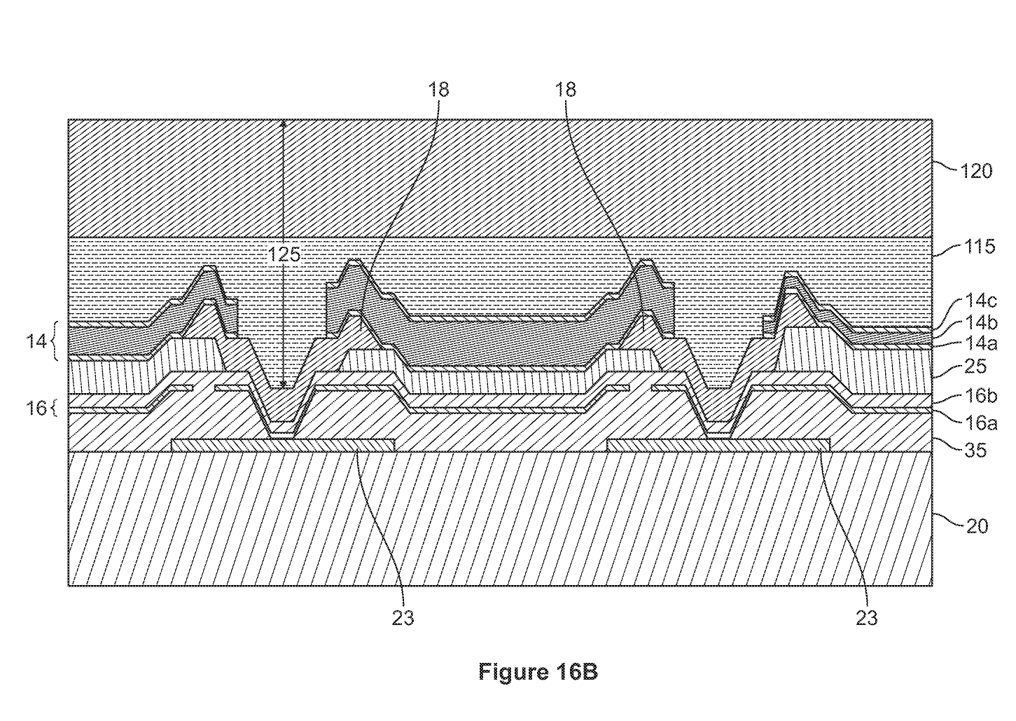

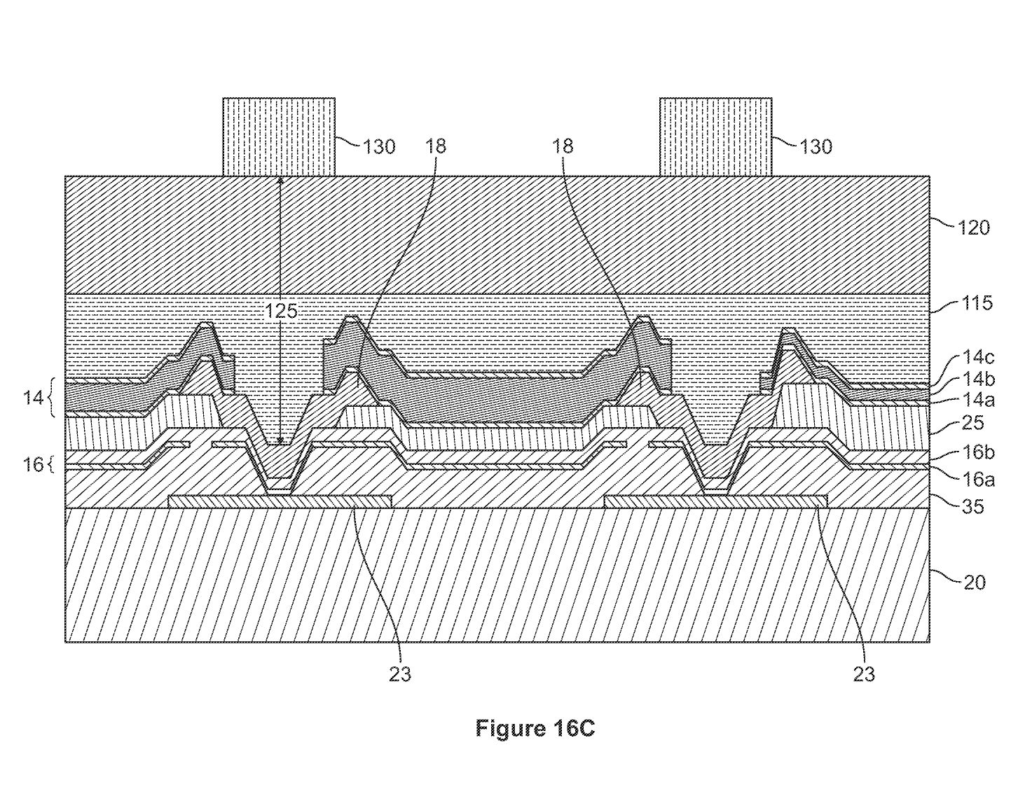

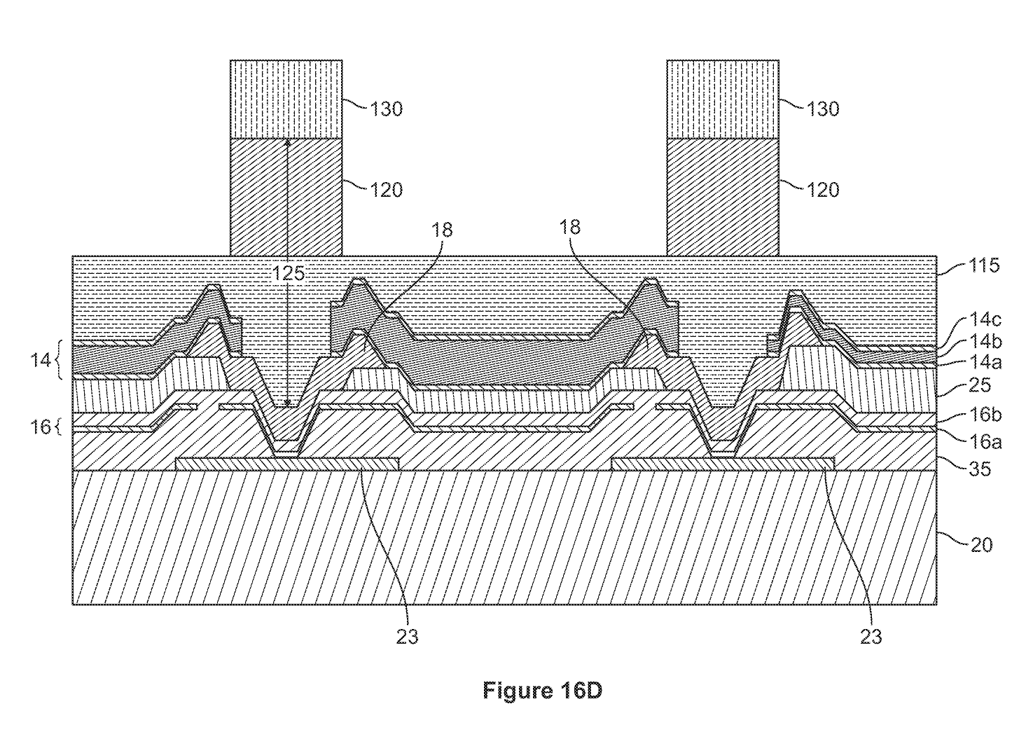

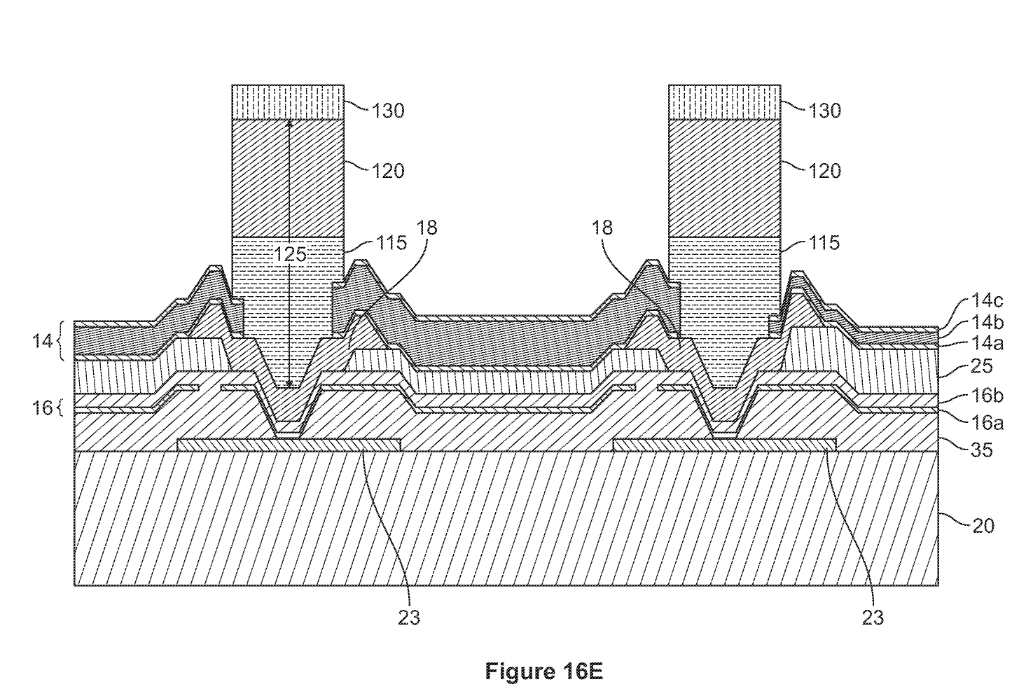

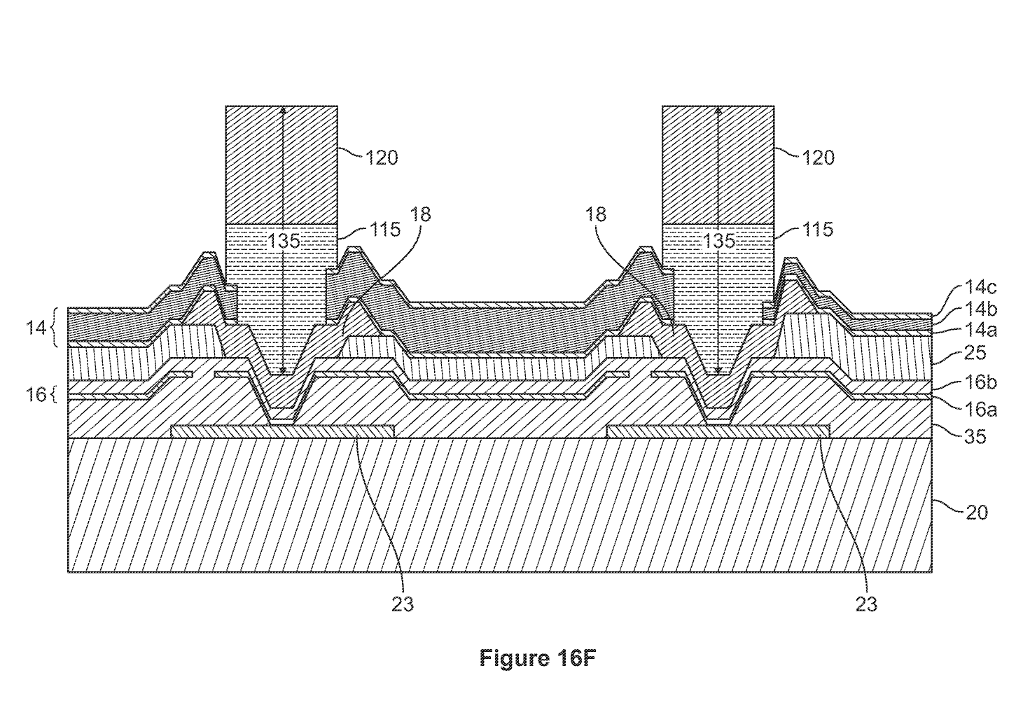

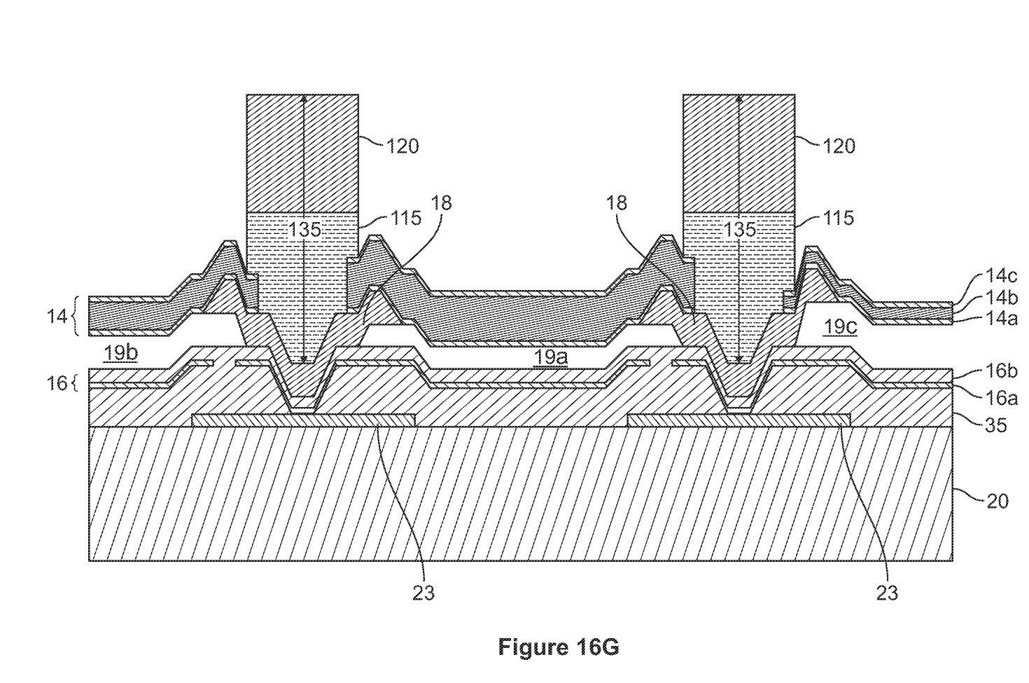

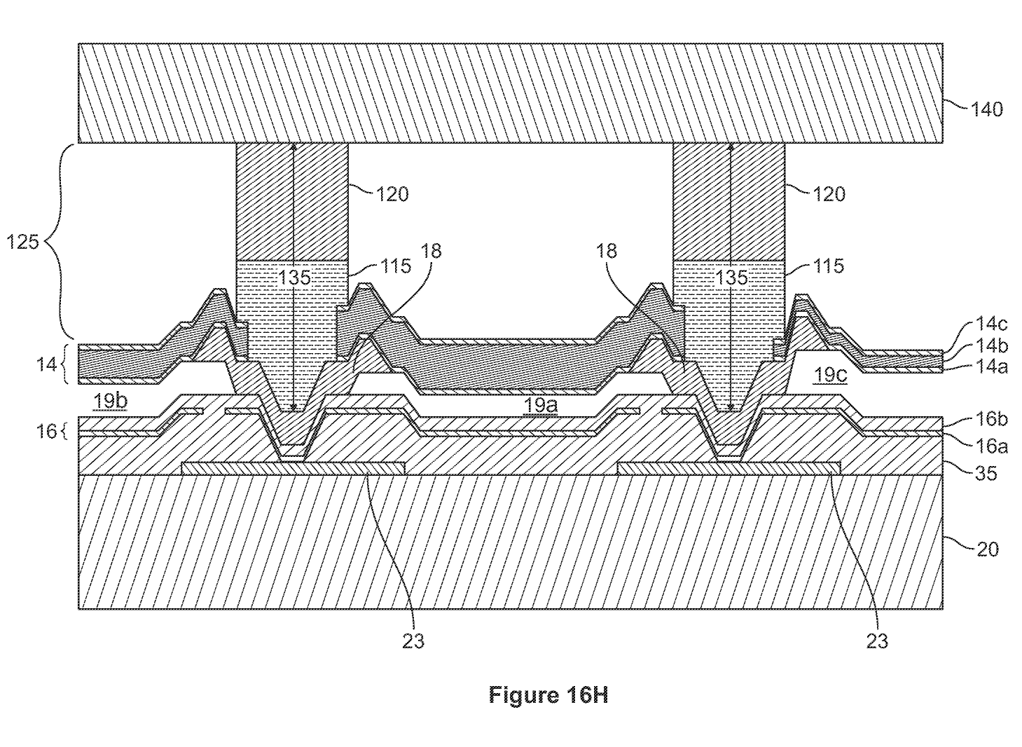

The process 1500 proceeds in block 1530 by forming a mask over the support layer. In particular, a negative or positive photoresist layer can be applied over the sections of the support layer above the support posts, so that one or more spacers (e.g., support structures) may be patterned. The photoresist layer can be formed of any suitable polymer material. A reticle is provided over the photoresist layer so as to expose some portions of the photoresist to light. Development of the exposed photoresist leaves the mask in the desired pattern for spacers supporting the cover plate. In the example of FIGS. 16A-16H below, the pattern corresponds to the positions of at least some underlying support posts for supporting electromechanical systems device.

The process 1500 continues in block 1535 by etching the support layer through the mask to form one or more support structures or spacers. The etching of block 1535 can be in two stages for controlled etching of inorganic/polymer bilayer of the support layer. First, the support layer can be subjected to a dry etch selective to the inorganic dielectric spacer material, e.g., SiO₂ or SiOₓN_{y}. The etchant for patterning the support layer may be a fluorine-based etchant, for example and without limitation, CF₄ plus O₂, or carbon trifluoride (CHF₃) plus O₂. In some implementations, the fluorine-based etchant effectively stops on the polymer layer due to the extremely slow etching of the polymer material. Only small amounts of O₂ are employed to reduce polymer “scum” build-up from interaction of CF₄ with the photoresist.

Second, the remainder of the support layer can be subjected to a plasma etch, such as a low bias oxygen (O₂) plasma etch that is selective to the polymer layer. The low bias O₂ plasma etch effectively stops on the materials (Mo, SiO₂, and SiOₓN_{y}) underneath the polymer layer. Therefore, the materials forming the underlying array of electromechanical systems devices are not damaged by the etching process. Finally, the patterning process is completed by removing the remaining photoresist.

The process 1500 continues at block 1540 where the sacrificial layer is removed to form a gap between the movable electrode and the stationary electrode. The sacrificial layer may be removed using a variety of techniques, such as by exposing the sacrificial layer to a fluorine-based vapor phase etchant like xenon difluoride (XeF₂). As a person having ordinary skill in the art will recognize, the sacrificial layer can be exposed for a period of time that is effective to remove the material, typically selective relative to the structures surrounding the gap. Other selective etching methods, for example, wet etching and/or plasma etching, can also be used, depending upon the materials of the sacrificial material and the array structures. As a result, the movable electrode is “released” at this stage, and can become displaced toward the stationary electrode by an application of voltage.

The process 1500 continues at block 1545 where a cover plate is provided over the one or more support structures, which can be similar to block 1425 in FIG. 11 as previously discussed herein. The skilled artisan will appreciate that the release etch can follow mounting the cover plate in some arrangements.

FIGS. 16A-16H show an example of a series of schematic cross sections illustrating a process for manufacturing an electromechanical systems device corresponding to FIG. 15. While particular parts and steps are described as suitable for interferometric modulator (IMOD) implementations, a person having ordinary skill in the art will readily understand that for other electromechanical systems implementations, such as nano- or micro-electromechanical systems (NEMS OR MEMS) implementations, different materials can be used and structures can be modified, omitted, or added.

In FIG. 16A, an implementation of an IMOD is provided similar to that of FIG. 9. A polymer layer 115 is deposited over the movable reflective layer 14 and support posts 18. The polymer layer 115 can have a thickness between about 0.3 μm and about 5.0 μm, e.g., between about 0.5 μm and about 1.5 μm. The polymer layer 115 may be deposited by self-planarizing deposition e.g., spin-on deposition, extrusion coating, liquid before cure, etc., as discussed herein above.

In some implementations, the polymer layer 115 can be a high temperature planar polymer material, such as a fluorinated polymer. Examples of fluorinated polymers can include a polyimide, polyurethane, polyester, polyacrylate, polyfluoroalkene, polystyrene, and polyamide. As a high temperature polymer, the polymer may be selected so that the material avoids out-gassing at temperatures up to 350° C. Thus, when the material is exposed to a high temperature cure, the polymer material does not decompose. One example of a high temperature planar polymer material includes AL-X2000, manufactured by Asahi Glass Company, Ltd., of Tokyo Japan. Others may include AL-X543, HD-4104, and HD-8820, also manufactured by Asahi Glass Corporation.

With respect to mechanical properties, the polymer can be selected so that it is more elastic than inorganic dielectric spacers, but stiff enough so that it does not readily deform upon changes in pressure. In some implementations, the polymer can have a modulus of elasticity (e.g., Young's Modulus) between about 1.1 GPa and about 1.5 GPa, e.g., about 1.3 GPa. Furthermore, the polymer material can have a reduced Modulus below 9 GPa, e.g., between about 2 GPa and about 7 GPa. The polymer material can also be selected to have a tensile strength between about 83 MPa and about 104 MPa, e.g., about 90 MPa. Thus, the material of polymer layer 115 is selected so that the polymer layer 115 is not easily breakable, e.g., brittle, but has sufficient elasticity to absorb differential pressures experienced during subsequent mounting of a back cover plate 140 (see FIG. 16H).

With respect to electrical properties, the polymer can be selected to have a low dielectric constant, such as between about 2.6 and about 2.7. In addition, the polymer can undergo low temperature curing between about 180° C. and about 250° C.

FIG. 16B illustrates the result of depositing an inorganic spacer layer 120 over the polymer layer 115 to form a bilayered support layer 125. The thickness of the inorganic spacer layer 120 can be between about 1.5 μm and about 2.0 μm. As an inorganic material, spacer layer 120 can be made of a material stronger and more rigid than the polymer layer 115. In some implementations, the thickness of the inorganic spacer layer 120 is selected to supplement the strength of the underlying polymer layer 115 in order to withstand the force applied to the IMOD array during mounting of the cover plate 140 (FIG. 16H). To provide the strength comparable to 5 μm of polymer, for example, 1.5 μm to 2.0 μm of an inorganic dielectric, such as SiOₓ, SiNₓ, or SiOₓN_{y} can be added to the 1.0 to 1.5 μm polymer layer 115. The overall thinner layers for comparable strength facilitates resolution for the subsequent lithography and dry etch. SiNₓ or SiOₓN_{y} can be deposited by commercially available CVD or plasma CVD processes, e.g., at 350° C. or less.

FIG. 16C illustrates initial patterning of the support layer 125 by forming a mask 130 over the inorganic spacer layer 120. In the illustrated implementation, the mask 130 can include features (representing the spacer being formed) aligned over the support posts 18. However, as discussed below with respect to placement of spacers in the array, the spacers could be positioned at other locations in the array. Spacers can be provided for fewer than all support posts 18 within the array, e.g., every 4th post in the array can have a spacer formed thereover. Negative or positive photoresists can be used, or any other masking material (e.g., hard masks, imprint lithography, etc.).

FIG. 16D illustrates patterning the support layer 125 by etching the inorganic spacer layer 120. For example, SiNₓ and SiOₓN_{y} can be etched by fluorine-based chemicals. In some implementations, the fluorine-based etchant is CF₄ plus O₂, or carbon trifluoride (CHF₃) plus O₂, in which small amounts of O₂ help reduce formation of polymer scum from fluorocarbon and photoresist interaction. The underlying polymer layer 115 can function as an etch stopper because it is resistant to the fluorine-based etchant. Thus, the polymer layer 115 is able to protect, for example, the movable reflective layer 14 and inorganic support posts 18 from etch-related damage.

FIG. 16E illustrates continued patterning of the support layer 125 by etching the polymer layer 115. For example, low bias O₂ plasma etch can remove exposed portions of the polymer layer 115 without damaging underlying structural materials of the electromechanical systems device array, such as Al(Cu), Mo, SiO₂, or SiOₓN_{y}. Because the polymer etch does not attack underlying materials, a separate etch stopper layer under the polymer can be avoided.

FIG. 16F illustrates removal of the photoresist 130 from the top of the support layer 125. The photoresist 130 can be stripped away using conventional stripping processes, such as plasma ashing or a wet chemical strip. Following the removal of the photoresist 130, the upper surface of support layer 125 is exposed having a flat or planar top. This leaves a number of spacers 135 in the array of electromechanical systems devices, each of which includes a bilayer of polymer and inorganic material.

FIG. 16G illustrates removal of the sacrificial layer 25 from between the electrodes by “release” etching to form gaps for each electromechanical systems device. In the illustrated implementation, three gaps 19a, 19b, and 19c of different sizes are shown, representing different interferometrically reflected colors for IMODs, e.g., in the open position. A vapor phase etchant for the release can be a fluorine-based etchant, such as xenon-difluoride (XeF₂) or fluorine (F₂), etc. The vapor phase fluorine-based etchant can selectively remove sacrificial material (e.g., molybdenum, amorphous silicon, poly-Si, germanium, tungsten, or titanium) without removing other exposed materials, such as aluminum alloy, silicon oxide, silicon oxynitride, etc. The etchant can reach the sacrificial material through gaps between strips of the movable electrode 14 and/or etch holes in the movable electrode 14 (not shown). Other etching methods, e.g., wet etching and/or plasma etching, may also be used. Upon release, the movable electrode 14 can move across the gap 19a, 19b, or 19c. For the illustrated IMOD implementation, the gaps 19a, 19b, and 19c function as the optical cavities for interferometric operation in the open state, together with the dielectric layer 16b of the optical stack 16.

FIG. 16H illustrates providing a cover plate 140 over the spacers 135. The cover plate 140 covers the array of the electromechanical systems devices (e.g., IMODs), in addition to at least a portion of peripheral areas that include routing and pads for control integrated circuits (not shown). In some implementations, an adhesive is applied to the spacers 135 and/or cover plate 140. In yet some other implementations, the cover plate 140 is not adhered to the spacers 135 but rather the spacers 135 merely support the cover plate that can be secured to the substrate 20 at locations outside the array. The cover plate 140 can protect and seal the IMOD from ambient conditions, such as pressure, temperature, or environmental conditions. For that purpose, a seal can be provided between the cover plate 140 and the substrate 20, e.g., glass frit, surrounding the array.

As noted above, the spacers 135 are distributed within the array, and are shown overlying support structures or posts 18 that support the movable electrode 14 above the gap 19a, 19b, or 19c. While the spacers 135 could be positioned at other locations, alignment with at least some of the posts 18 can be economical and provide good distributed support without interfering with IMOD operation or placements. However, spacers 135 can be provided for fewer than all of the posts 18 in the array. For example, every 4th post in the array can have a spacer thereover.

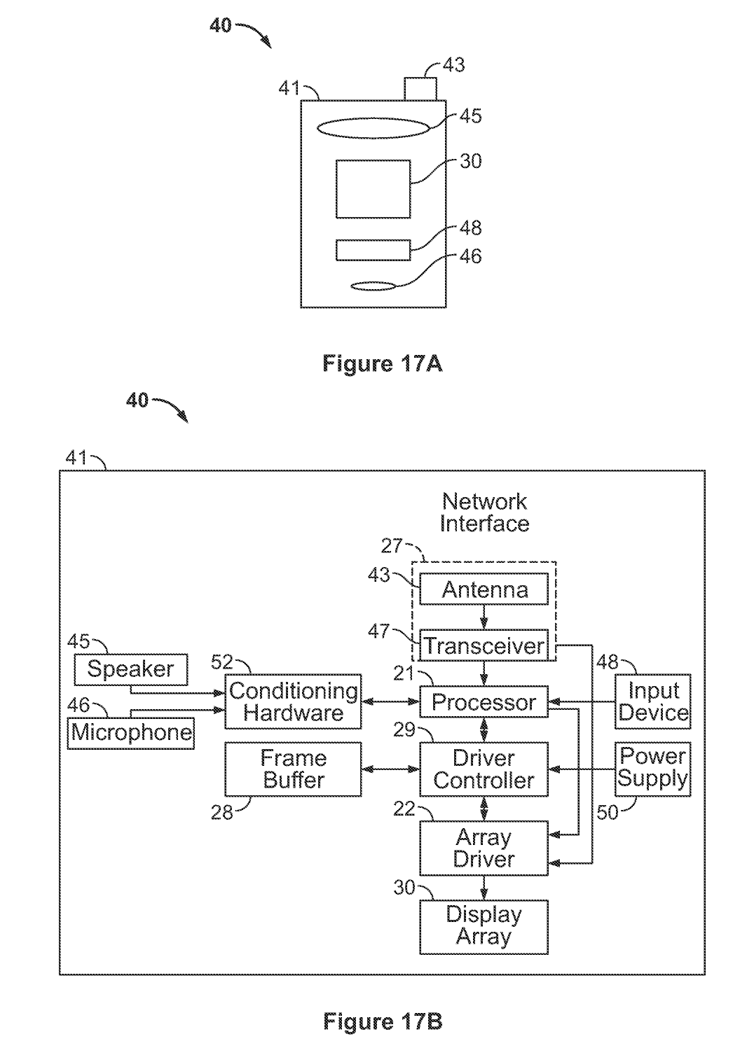

FIGS. 17A and 17B show examples of system block diagrams illustrating a display device 40 that includes a plurality of interferometric modulators. The display device 40 can be, for example, a cellular or mobile telephone. However, the same components of the display device 40 or slight variations thereof are also illustrative of various types of display devices such as televisions, e-readers and portable media players.

The display device 40 includes a housing 41, a display 30, an antenna 43, a speaker 45, an input device 48, and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber, and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an interferometric modulator display, as described herein.

The components of the display device 40 are schematically illustrated in FIG. 17B. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 can provide power to all components as required by the particular display device 40 design.

The network interface 27 includes the antenna 43 and the transceiver 47 so that the display device 40 can communicate with one or more devices over a network. The network interface 27 also may have some processing capabilities to relieve, e.g., data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g or n. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation, and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels.

In some implementations, the driver controller 29, the array driver 22, and the display array 30 are appropriate for any of the types of displays described herein. For example, the driver controller 29 can be a conventional display controller or a bi-stable display controller (e.g., an IMOD controller). Additionally, the array driver 22 can be a conventional driver or a bi-stable display driver (e.g., an IMOD display driver). Moreover, the display array 30 can be a conventional display array or a bi-stable display array (e.g., a display including an array of IMODs). In some implementations, the driver controller 29 can be integrated with the array driver 22. Such an implementation is common in highly integrated systems such as cellular phones, watches and other small-area displays.

In some implementations, the input device 48 can be configured to allow, e.g., a user to control the operation of the display device 40. The input device 48 can include a keypad, such as a QWERTY keyboard or a telephone keypad, a button, a switch, a rocker, a touch-sensitive screen, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices as are well known in the art. For example, the power supply 50 can be a rechargeable battery, such as a nickel-cadmium battery or a lithium-ion battery. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the disclosure is not intended to be limited to the implementations shown herein, but is to be accorded the widest scope consistent with the claims, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of the IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An electromechanical systems apparatus, comprising:
a substrate;
a stationary electrode positioned over the substrate;
a movable electrode spaced from the stationary electrode by a gap; and
at least one support structure extending above the movable electrode, the support structure including an inorganic dielectric layer and a polymer layer.

2. The electromechanical systems apparatus of claim 1, further comprising a cover plate supported over and spaced from the movable electrode, the cover plate supported by the support structure.

3. The electromechanical systems apparatus of claim 1, including an array of interferometric modulators disposed on the substrate of which the movable electrode is part, wherein the at least one support structure is disposed within the array.

4. The electromechanical systems apparatus of claim 3, including posts between each interferometric modulator, wherein at least some of the posts support the movable electrode and underlie the support structure.

5. The electromechanical systems apparatus of claim 1, wherein the inorganic dielectric layer overlies the polymer layer.

6. The electromechanical systems apparatus of claim 1, wherein the at least one support structure has a substantially planarized upper surface.

7. The electromechanical systems apparatus of claim 1, wherein the polymer layer has a modulus of elasticity between about 1.1 GPa and about 1.5 GPa.

8. The electromechanical systems apparatus of claim 1, wherein the polymer layer includes a polyimide.

9. The electromechanical systems apparatus of claim 1, wherein the inorganic dielectric layer includes a material chosen from the group of SiOₓ and SiOₓN_{y}.

10. The electromechanical systems apparatus of claim 1, wherein the polymer layer has a thickness between about 0.3 μm and about 5.0 μm.

11. The electromechanical systems apparatus of claim 10, wherein the polymer layer has a thickness between about 0.5 μm and about 1.5 μm.

12. The electromechanical systems apparatus of claim 1, wherein the inorganic dielectric layer has a thickness between about 1.5 μm and about 2.0 μm.

13. The electromechanical systems apparatus of claim 1, wherein the polymer layer is resistant to a fluorine plasma etchant.

14. The electromechanical systems apparatus of claim 1, further comprising:
a display;
a processor that is configured to communicate with the display, the processor being configured to process image data; and
a memory device that is configured to communicate with the processor.

15. The electromechanical systems apparatus as recited in claim 14, further comprising:
a driver circuit configured to send at least one signal to the display.

16. The electromechanical systems apparatus as recited in claim 15, further comprising:
a controller configured to send at least a portion of the image data to the driver circuit.

17. The electromechanical systems apparatus as recited in claim 14, further comprising:
an image source module configured to send the image data to the processor.

18. The electromechanical systems apparatus as recited in claim 17, wherein the image source module includes at least one of a receiver, transceiver, and transmitter.

19. The electromechanical systems apparatus as recited in claim 14, further comprising:
an input device configured to receive input data and to communicate the input data to the processor.

20. A display system, comprising
a substrate;
an array of electromechanical systems devices formed on the substrate, each electromechanical systems device comprising:
a stationary electrode formed on the substrate, and
a movable electrode spaced from the stationary electrode by a gap; and
a plurality of support structures within the array, wherein each support structure extends above the array, wherein a plurality of the support structures include an inorganic dielectric layer and a polymer layer.

21. The display system of claim 20, further comprising a cover plate above the array, wherein each support structure is between the cover plate and the array.

22. The display system of claim 20, wherein each support structure has a substantially planarized upper surface.

23. The display system of claim 20, wherein each support structure within the array has substantially the same height.

24. The display system of claim 20, wherein the inorganic dielectric layer overlies the polymer layer.

25. The display system of claim 20, including a plurality of posts disposed within the array and above the substrate, wherein each support structure overlies one of the posts.

26. An electromechanical systems apparatus, comprising:
a substrate;
a stationary electrode positioned over the substrate;
a movable electrode spaced from the stationary electrode by a gap; and
means for spacing from the movable electrode, wherein the means for spacing includes an inorganic dielectric layer and a polymer layer.

27. The electromechanical systems apparatus of claim 26, further comprising covering means for protecting the electromechanical systems apparatus.

28. The electromechanical systems apparatus of claim 26, including an array of interferometric modulators, wherein the means for spacing are disposed within the array.

29. The electromechanical systems apparatus of claim 26, wherein the inorganic dielectric layer overlies the polymer layer.

30. A method of manufacturing an electromechanical systems apparatus, comprising:
providing an electromechanical systems device having a substrate, a stationary electrode above the substrate, and a movable electrode above the stationary electrode; and
forming a support layer over the movable electrode, wherein the support layer includes an inorganic dielectric layer over a polymer layer.

31. The method of claim 30, further comprising providing a cover plate over the support layer.

32. The method of claim 30, further comprising:
forming a mask over the support layer; and
patterning the support layer to form a plurality of support structures that space the cover plate from the movable electrode.

33. The method of claim 32, wherein patterning the support layer includes dry etching the inorganic dielectric layer.

34. The method of claim 32, wherein patterning the support layer includes oxygen plasma etching the polymer layer.

35. The method of claim 30, wherein forming the support layer includes self-planarizing deposition of the polymer layer prior to depositing the inorganic dielectric layer.

36. The method of claim 30, further comprising:
depositing a sacrificial layer over the stationary electrode, the sacrificial layer between and the stationary electrode and the movable electrode; and
removing the sacrificial layer by applying an etchant.

37. An electromechanical systems apparatus produced by the method as recited in claim 30.
